(19) United States
(12) Patent Application Publication
(10) Pub. No.: US 2026/0119097 A1
(43) Pub. Date: Apr. 30, 2026

(54) IMAGE PROCESSING METHOD, IMAGE PROCESSING DEVICE, PRINTING SYSTEM, AND NON-TRANSITORY COMPUTER-READABLE STORAGE MEDIUM STORING IMAGE PROCESSING PROGRAM

(71) Applicant: SEIKO EPSON CORPORATION, Tokyo (JP)

(72) Inventors: Takuya ONO, SHIOJIRI-SHI (JP); Takahiro KAMADA, MATSUMOTO-SHI (JP); Mitsuhiro YAMASHITA, MATSUMOTO-SHI (JP); Yuko YAMAMOTO, SHIOJIRI-SHI (JP)

(21) Appl. No.: 19/090,885

(22) Filed: Mar. 26, 2025

(30) Foreign Application Priority Data
Mar. 28, 2024 (JP) 2024-053766

(51) Int. Cl. G06F 3/12

(52) U.S. Cl. CPC G06F 3/1256; G06F 3/1205; G06F 3/1208

(57) ABSTRACT

An image processing method includes: (a) acquiring image data, (b) acquiring a print condition including at a type of the print medium, a type of printing, and/or a number of print layers, (c) displaying at least one preview image, based on the print condition, (d) when left-right reversal processing is required, executing the left-right reversal processing, (e) determining an arrangement position at which the print layer is arranged on the print medium and a stacking order in which a plurality of the print layers are stacked, according to the print condition, and (f) outputting print data, the print data designating the type of the print medium, the arrangement position, the stacking order, and the image on which the left-right reversal processing is executed or the left-right reversal processing is not executed, in order to print the image on the print medium.

The present application is based on, and claims priority from JP Application Serial Number 2024-053766, filed Mar. 28, 2024, the disclosure of which is hereby incorporated by reference herein in its entirety.

### BACKGROUND

### 1. Technical Field

The present disclosure relates to an image processing method, an image processing device, a printing system, and a non-transitory computer-readable storage medium storing an image processing program.

### 2. Related Art

JP-A-2017-159552 describes a technique related to an image processing device that accepts, from a user, a designation of a type of a print medium, a type of a color material to be used in each layer, and an order of printing each layer, when performing multilayer printing.

JP-A-2017-159552 is an example of the related art.

In the technique described in JP-A-2017-159552, the user himself or herself needs to perform a complex task of designating the type of the color material to be used in each layer of up to five layers, and the order of printing each layer. Therefore, a technique with good operability for the user is desired.

### SUMMARY

The present disclosure can be implemented according to the aspects given below.

According to a first aspect of the present disclosure, an image processing method is provided. The image processing method includes: (a) acquiring image data representing an image to be formed on a print medium; (b) acquiring a print condition including at least one of a type of the print medium, a type of printing, and a number of print layers; (c) displaying, on a display device, at least one preview image representing a state where the image is formed on the print medium, based on the print condition; (d) when left-right reversal processing is required based on the print condition, executing the left-right reversal processing of the image; (e) determining an arrangement position at which the print layer is arranged on the print medium and a stacking order in which a plurality of the print layers are stacked when the number of the print layers is a plurality, according to the print condition; and (f) outputting print data to a printing device, the print data designating the type of the print medium, the arrangement position, the stacking order, and the image on which the left-right reversal processing is executed or the left-right reversal processing is not executed, in order to print the image on the print medium.

According to a second aspect of the present disclosure, an image processing device is provided. The image processing device includes: an image data acquisition unit that acquires image data representing an image to be formed on a print medium; a print condition acquisition unit that acquires a print condition including at least one of a type of the print medium, a type of printing, and a number of print layers; a preview image generation unit that displays, on a display device, a preview image representing a state where the image is formed on the print medium, based on the print condition; and a print data generation unit that, when left-right reversal processing is required based on the print condition, executes the left-right reversal processing of the image, determines an arrangement position at which the print layer is arranged on the print medium and a stacking order in which a plurality of the print layers are stacked when the number of the print layers is a plurality, according to the print condition, and outputs print data to a printing device, the print data designating the type of the print medium, the arrangement position, the stacking order, and the image on which the left-right reversal processing is executed or the left-right reversal processing is not executed, in order to print the image on the print medium.

According to a third aspect of the present disclosure, a printing system is provided. The printing system includes an image processing device, a printing device, and a display device. The image processing device includes: an image data acquisition unit that acquires image data representing an image to be formed on a print medium; a print condition acquisition unit that acquires a print condition including at least one of a type of the print medium, a type of printing, and a number of print layers; a preview image generation unit that displays, on the display device, a preview image representing a state where the image is formed on the print medium, based on the print condition; and a print data generation unit that, when left-right reversal processing is required based on the print condition, executes the left-right reversal processing of the image, determines an arrangement position at which the print layer is arranged on the print medium and a stacking order in which a plurality of the print layers are stacked when the number of the print layers is a plurality, according to the print condition, and outputs print data to the printing device, the print data designating the type of the print medium, the arrangement position, the stacking order, and the image on which the left-right reversal processing is executed or the left-right reversal processing is not executed, in order to print the image on the print medium. The printing device receives the print data, and executes printing on the print medium, based on the print condition included in the print data.

According to a fourth aspect of the present disclosure, a non-transitory computer-readable storage medium storing an image processing program is provided. The image processing program causes a computer to implement: a function of acquiring image data representing an image to be formed on a print medium; a function of acquiring a print condition including at least one of a type of the print medium, a type of printing, and a number of print layers; a function of displaying, on a display device, a preview image representing a state where the image is formed on the print medium, based on the print condition; a function of, when left-right reversal processing is required based on the print condition, executing the left-right reversal processing of the image; a function of determining an arrangement position at which the print layer is arranged on the print medium and a stacking order in which a plurality of the print layers are stacked when the number of the print layers is a plurality, according to the print condition; and a function of outputting print data to a printing device, the print data designating the type of the print medium, the arrangement position, the stacking order, and the image on which the left-right reversal processing is executed or the left-right reversal processing is not executed, in order to print the image on the print medium.

### BRIEF DESCRIPTION OF THE DRAWINGS

FIG. 1 is a block diagram showing a schematic configuration of a printing system according to a first embodiment.

FIG. 2 is a diagram illustrating an example of a printed object formed by printing an image on a transparent print medium.

FIG. 3 is a diagram illustrating an example of a printed object formed by printing an image on a transparent print medium.

FIG. 4 is a diagram illustrating an example of a printed object formed by printing an image on a transparent print medium.

FIG. 5 is a diagram illustrating an example of a printed object formed by printing an image on a transparent print medium.

FIG. 6 is a diagram illustrating a configuration of an image processing device.

FIG. 7 is a diagram illustrating an example of a user interface for inputting image data.

FIG. 8 is a diagram illustrating processing contents of CMS.

FIG. 9 is a diagram illustrating a flow of color conversion processing.

FIG. 10 is a diagram illustrating a configuration of a rendering unit.

FIG. 11 is a flowchart showing processing related to printing executed in the image processing device.

FIG. 12 is a diagram schematically illustrating a state where a front surface of a printed object expressed as a 3D object in a virtual space is observed.

FIG. 13 is a diagram schematically illustrating a state where a back surface of the printed object expressed as a 3D object in the virtual space is observed.

FIG. 14 is a flowchart of processing of generating print data in step S40 in FIG. 11.

FIG. 15 is a diagram illustrating a printed object according to a second embodiment.

FIG. 16 is a diagram illustrating another printed object according to the second embodiment.

FIG. 17 is a diagram illustrating still another printed object according to the second embodiment.

FIG. 18 is a diagram illustrating another printed object.

FIG. 19 is a diagram illustrating another example of the user interface for inputting image data.

FIG. 20 is a diagram illustrating an input operation on the user interface in the second embodiment.

FIG. 21 is a diagram related to a method of printing a printed object.

FIG. 22 is a diagram related to a method of printing another printed object.

FIG. 23 is a diagram illustrating a printed object according to a third embodiment.

FIG. 24 is a diagram illustrating front printing.

FIG. 25 is a diagram illustrating back printing.

FIG. 26 is a flowchart of processing of generating print data according to a fourth embodiment.

FIG. 27 is a diagram related to a form of printing.

### DESCRIPTION OF EMBODIMENTS

### A. First Embodiment

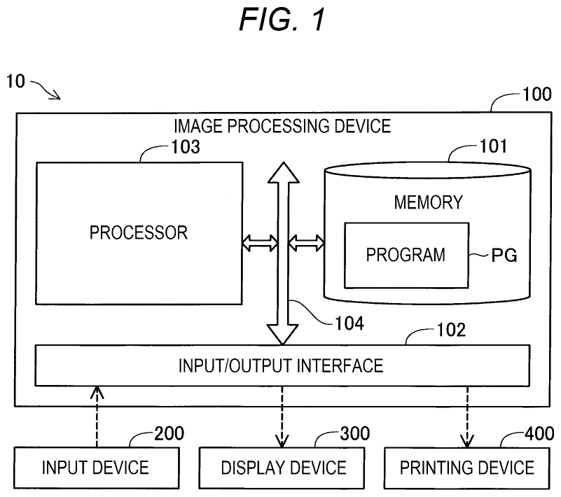

FIG. 1 is a block diagram illustrating a schematic configuration of a printing system 10 according to the present embodiment. The printing system 10 includes an image processing device 100, an input device 200, a display device 300, and at least one printing device 400. The printing system 10 functions as a printing device in a broad sense.

The image processing device 100 generates a rendered image corresponding to how a printed object looks in a three-dimensional virtual space by physically based rendering (hereinafter simply referred to as rendering). Before executing printing, the image processing device 100 causes the display device 300 to display the generated rendered image as a preview image. In the present embodiment, how the printed object looks in the three-dimensional virtual space is prescribed by the position and the attitude of the three-dimensional object in the virtual space, and the viewpoint position and the line-of-sight direction of the user in relation to the three-dimensional object in the virtual space.

The printing device 400 is an inkjet-type printing device and directly prints an image on a print medium. In this embodiment, the printing device 400 prints an image on a transparent print medium. The print medium is flat plate-shaped. As the print medium, a transparent film or sheet formed of a material such as polypropylene (PP), polyethylene (PET), or polyvinyl chloride (PVC) can be used. Also, as the print medium, a transparent plate formed of a material such as acrylic or glass can be used. However, the print medium may be translucent. The transparent print medium may have, for example, an average transmittance of 80% or higher for visible light. The translucent print medium may have, for example, an average transmittance of 30% or higher, and lower than 80% for visible light. In the present embodiment, processing using a transparent print medium is described. Substantially the same processing can be applied whether a translucent print medium is used or an opaque print medium is used.

The printing device 400 can perform printing using a spot color ink in addition to printing using CMYKLcLm inks (hereinafter referred to as process inks). C is a cyan process ink, M is a magenta process ink, Y is a yellow process ink, K is a black process ink, Lc is a light cyan process ink, and Lm is a light magenta process ink. The spot color is a color other than the process colors CMYKLcLm. In the present embodiment, the spot color ink is used as a foundation ink. As the foundation ink, a white ink, a silver ink, a gold ink, or the like can be used. In the present embodiment, a white ink is used as the foundation ink.

The printing device 400 can perform back printing in addition to front printing. Front printing refers to printing on a front surface of a print medium. In the present specification, the front surface of the print medium refers to the surface on the side where a printed object is assumed to be observed. The back surface is the surface opposite to the front surface. Back printing refers to printing on the back surface of a transparent print medium with the orientation of the image and the order of printing reversed. The back-printed image can be seen through the transparent print medium. Back printing enables the provision of a printed object having transparency or gloss. Some examples of front printing and back printing will be described below.

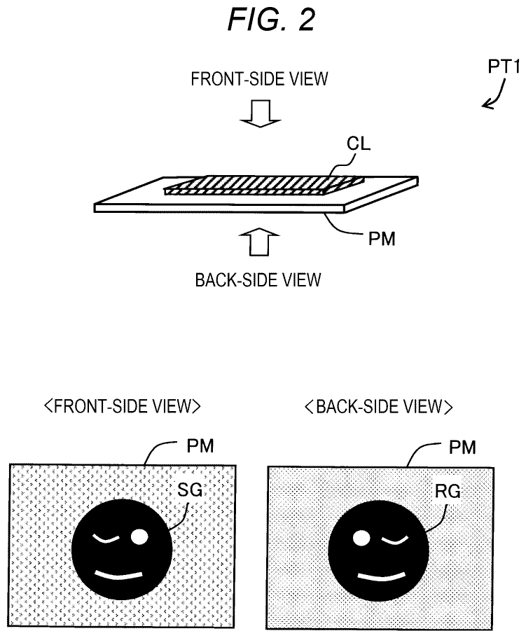

FIG. 2 is a diagram illustrating a printed object PT1 formed by printing an image on a transparent print medium. In the printed object PT1, a color layer CL in which a front-surface image SG is formed is formed on the front surface of a transparent print medium PM. The printed object PT1 is printed by front printing. The color layer CL is formed by printing plates of the respective process colors. The color layer CL is formed by a set of dots of the process inks. The thickness of the layer is exaggerated for the sake of convenience of illustration. While it is assumed that the printed object PT1 is to be observed only from the front surface side, a back-surface image RG, which a left-right reversed image of front-surface image SG, is seen when the printed object PT1 is observed from the back surface side. The left-right reversed image is also referred to as a mirror-reversed image.

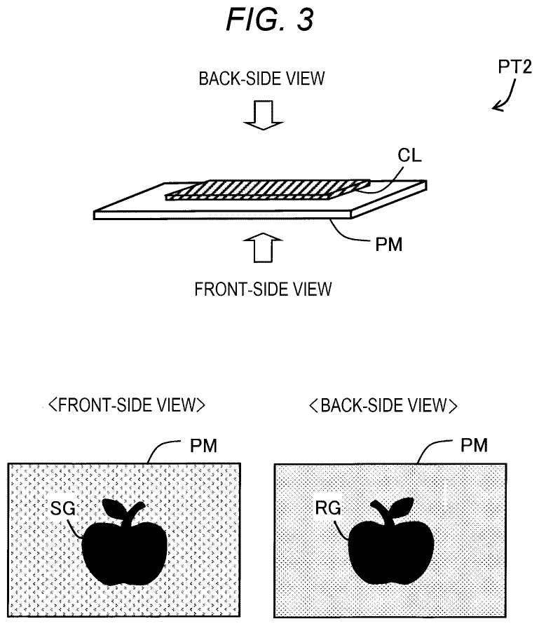

FIGS. 3 to 5 are diagrams illustrating other examples of a printed object formed by printing an image on a transparent print medium. In FIGS. 3 to 5, the thickness of each layer is exaggerated for the sake of convenience of illustration. FIGS. 2 to 5 show an example of a printed object in which a print layer is formed on at least one of the front surface and the back surface of the print medium PM. The print layer includes the color layer CL and a foundation layer WL, described later. The foundation layer WL is formed of a foundation ink and serves as a foundation of the color layer CL.

In a printed object PT2 shown in FIG. 3, the color layer CL forming the back-surface image RG is printed on the back surface of the transparent print medium PM. The printed object PT2 is printed by back printing. FIG. 3 illustrates a state where the printed object PT2 is disposed in such a way that the back surface of the print medium PM is located on the upper side. Since the print medium PM is transparent, the front-surface image SG, which is a left-right reversed image of the back-surface image RG, is seen through the print medium PM when observed from the front surface side.

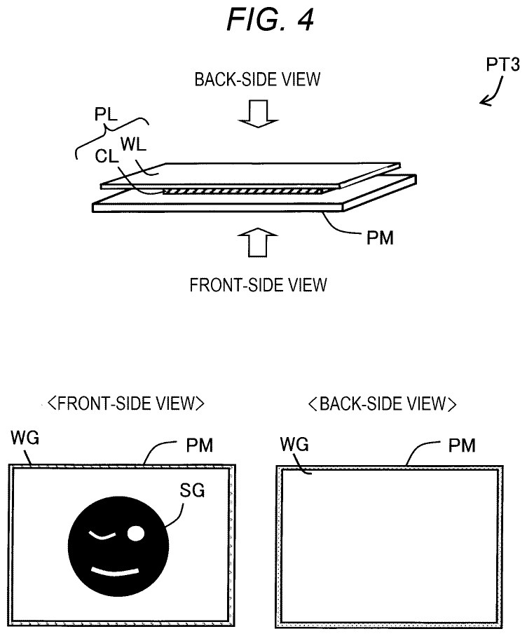

In a printed object PT3 shown in FIG. 4, the color layer CL forming the front-surface image SG and the foundation layer WL are stacked in this order on the back surface of the transparent print medium PM. FIG. 4 illustrates a state where the printed object PT3 is disposed in such a way that the back surface of the print medium PM is located on the upper side. The foundation layer WL is formed by a set of dots of the foundation layer ink. The foundation layer WL functions as the foundation of the color layer CL. The foundation layer WL is formed over substantially the entire back surface of the print medium PM. Since the printed object PT3 is printed by back printing, the front-surface image SG and a foundation area WG arranged around the front-surface image SG are seen through the print medium PM when observed from the front surface side. It is assumed that the printed object PT3 is to be observed only from the front surface side. When observed from the back surface side, only the foundation area WG is seen over substantially the entire back surface of the print medium PM. In this case, the left-right reversed image of the front-surface image SG is invisible.

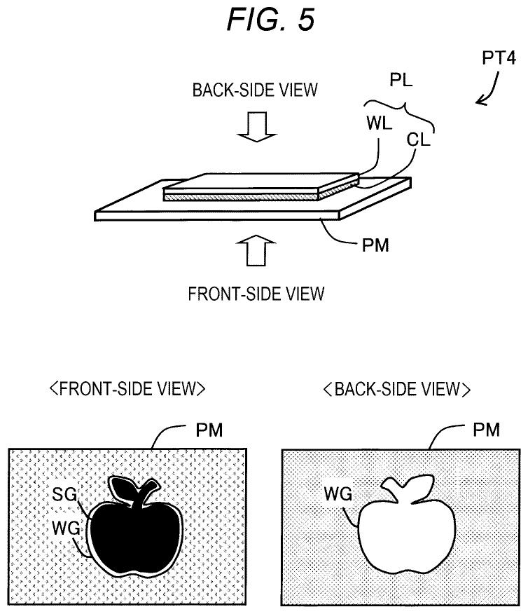

In a printed object PT4 shown in FIG. 5, the color layer CL forming the front-surface image SG and the foundation layer WL are stacked in this order on the back surface of the transparent print medium PM. FIG. 5 illustrates a state where the printed object PT4 is disposed in such a way that the back surface of the print medium PM is located on the upper side. The foundation layer WL is formed only in a range overlapping the front-surface image SG on the back surface of the print medium PM. More specifically, the foundation layer WL is formed in a range slightly broader than the range indicated by the outline of the front-surface image SG. It is assumed that the printed object PT4 is to be observed only from the front surface side. When observed from the front surface side, the front-surface image SG and a part of the foundation area WG superimposed on the front-surface image SG are seen through the print medium PM. When observed from the back surface side, the foundation area WG is seen, but the reversed mirror image of the front-surface image SG is invisible.

As shown in FIG. 1, the image processing device 100 is a computer including a memory 101, an input/output interface 102, a processor 103, and an internal bus 104. The memory 101, the input/output interface 102, and the processor 103 are communicably coupled via the internal bus 104. The memory 101 stores various programs and various data used for various processing executed by the image processing device 100. The memory 101 stores a program PG. The input device 200, the display device 300, and the printing device 400 are connected to the input/output interface 102 by wired communication or wireless communication. The processor 103 executes the programs stored in the memory 101 and thus implements various functions. The input device 200 is, for example, a keyboard or a mouse. The display device 300 is, for example, a liquid crystal display or an organic electro-luminescence (EL)display.

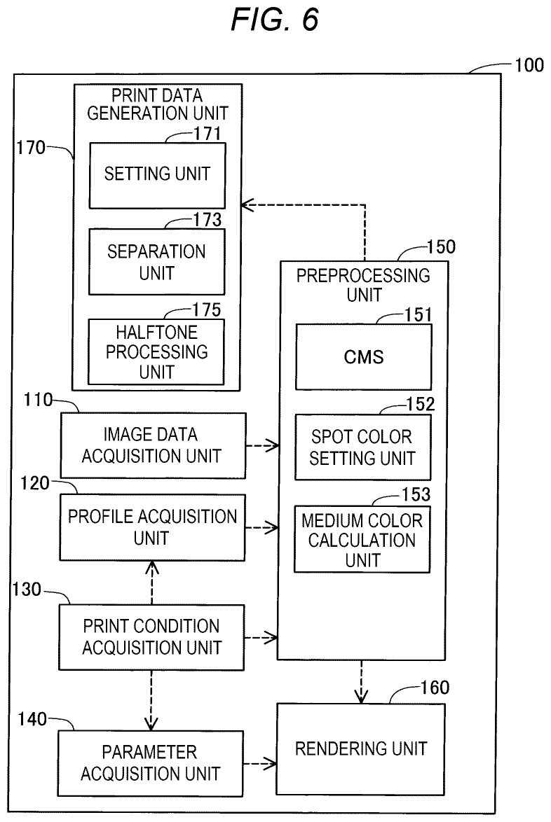

FIG. 6 is a diagram showing a schematic configuration of the image processing device 100. The image processing device 100 includes an image data acquisition unit 110, a profile acquisition unit 120, a print condition acquisition unit 130, a parameter acquisition unit 140, a preprocessing unit 150, a rendering unit 160, and a print data generation unit 170. The functions of these units are implemented by the processor 103 executing the program PG stored in the memory 101 shown in FIG. 1. The rendering unit 160 is also referred to as a “preview image generation unit”.

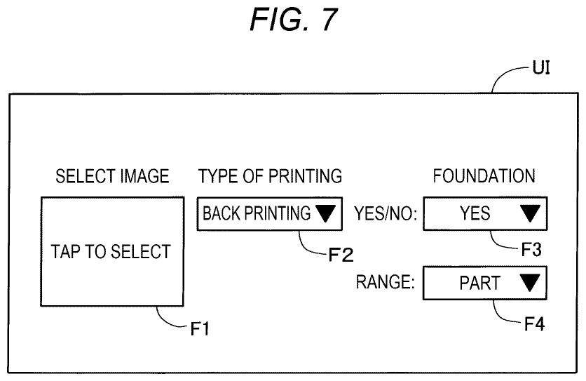

FIG. 7 is a diagram illustrating an example of a user interface UI for inputting image data. The user interface UI is displayed on the display device 300 under the control of the processor 103.

The user interface UI is provided with a first input field F1 for inputting image data, a second input field F2 for inputting a type of printing, a third input field F3 for inputting whether a foundation layer is present, and a fourth input field F4 for inputting a range in which a foundation is formed. The user can tap the first input field F1 and thus can select, for example, image data stored in advance in the memory 101 of the image processing device 100. In the second input field F2, “front printing” or “back printing” can be selected as the type of printing. In the third input field F3, “YES” or “NO” about the presence of the foundation can be selected. In the fourth input field F4, a range in which printing is performed with the foundation ink can be designated. In the present embodiment, in the fourth input field F4, “entire surface” indicating that printing is performed on the entire printing surface of the print medium PM with the foundation ink, and “part” indicating that printing is performed at a part of the printing surface of the print medium PM with the foundation ink. In the present embodiment, when “part” is selected as the range in which the foundation is printed, the foundation layer is formed corresponding to the range occupied by the color layer CL.

The image data acquisition unit 110 illustrated in FIG. 6 acquires image data selected in the first input field F1 (see FIG. 7) of the user interface UI. The image data selected in the first input field F1 is referred to as input image data IMi. The input image data IMi represents an image to be formed on a print medium. The input image data IMi is transmitted to the preprocessing unit 150.

The profile acquisition unit 120 acquires an input profile IPF, a media profile MPF, and a common color space profile CPF stored in advance in the memory 101. In FIG. 1, the input profile IPF, the media profile MPF, and the common color space profile CPF are not shown. The input profile IPF, the media profile MPF, and the common color space profile CPF are used for color conversion by a color management system 151 of the preprocessing unit 150, described later. Details of each profile will be described later. The each of acquired profiles are transmitted to the preprocessing unit 150. The profile acquisition unit 120 may acquire each profile from an external server via a network, not illustrated.

The print condition acquisition unit 130 acquires a print condition. The print condition includes conditions such as the type of the print medium, the type of printing, the number of print layers, the type of the ink of each print layer, whether to use the foundation ink, the resolution of printing, the type of the printing device, and whether the printing is single-sided printing or double-sided printing. The print condition acquired by the print condition acquisition unit 130 is transmitted to the profile acquisition unit 120, the preprocessing unit 150, and the parameter acquisition unit 140.

The parameter acquisition unit 140 acquires various parameters used for rendering from the memory 101. The various parameters are stored in advance in the memory 101. The various parameters used for rendering include, for example, three-dimensional object information (hereinafter referred to as 3D object information), camera information, illumination information, and medium parameters. The 3D object information is a parameter related to the shape of the print medium as a three-dimensional object (hereinafter, referred to as a 3D object) arranged in a virtual space. The camera information is a parameter related to the position and orientation of the camera arranged in the virtual space. The illumination information is a parameter related to the type of the light source arranged in the virtual space, the position and orientation of the light source, the color, and the luminous intensity (light amount). The type of the light source includes, for example, a fluorescent lamp and an incandescent lamp.

The medium parameter is a parameter related to the texture of the print medium. In the present embodiment, the medium parameter includes a texture parameter representing the texture of the print medium, and a light transmissivity parameter representing the light transmissivity of the print medium. Each texture parameter includes, for example, a base color related to the ground color of the print medium, a smoothness representing the smoothness of the print medium, a metallic property representing the metallic property of the print medium, a normal map, and a height map. When the metallic property is high, the surrounding landscape is likely to appear on the print medium. Each texture parameter may include a roughness representing the roughness of the print medium instead of the smoothness. The normal map and the height map are used to express minute unevenness of the print medium that affects reflection of light. The normal map is a texture representing the distribution of normal vectors of the minutely uneven surface. The height map is a texture representing the height distribution of the minutely uneven surface. When the size of polygons forming a 3D object is reduced in order to express minute unevenness, the number of polygons massively increases and the calculation load of rendering increases. As the normal map and the height map are used, the influence of the minutely uneven surface on the reflection of light can be expressed without reducing the size of the polygons. The light transmissivity parameter includes a medium transmittance representing the light transmittance (transparency) of the print medium. The light transmissivity parameter may include a medium opacity representing the light opacity (opacity) of the print medium.

The various parameters acquired by the parameter acquisition unit 140 are transmitted to the rendering unit 160. The parameter acquisition unit 140 may acquire various parameters from an external server via a network, not illustrated.

The preprocessing unit 150 includes the color management system 151, a spot color setting unit 152, and a medium color calculation unit 153. Hereinafter, the color management system 151 may be simply referred to as the CMS 151.

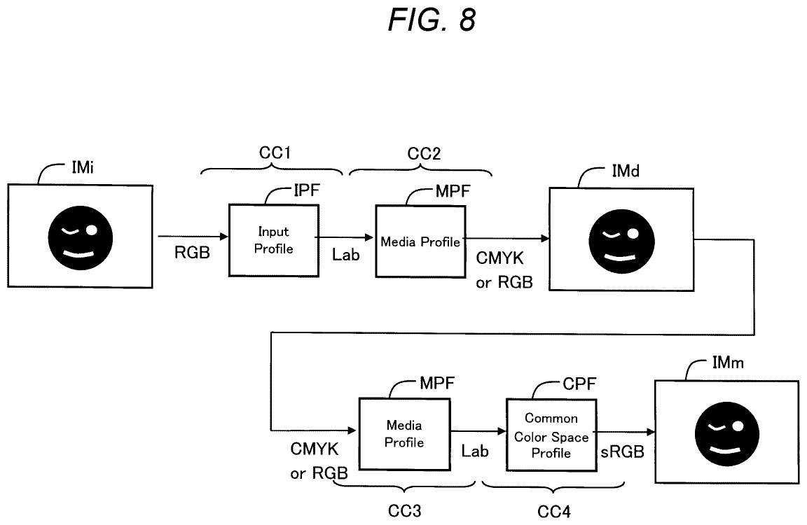

FIG. 8 is a diagram illustrating the processing contents of the CMS 151. The CMS 151 executes various kinds of color conversion processing using each profile acquired by the profile acquisition unit 120.

The input profile IPF is an International Color Consortium (ICC) profile used for color conversion from a color space (input color space) of image data to a device-independent color space. The input color space is, for example, an RGB color space. The device-independent color space is, for example, a CIE-L*a*b* color space. The media profile MPF is an ICC profile used for color conversion from the device-independent color space to a device-dependent color space for the printing device 400. The device-dependent color space for the printing device 400 is, for example, a CMYK color space. A color in the device-dependent color space for the printing device 400 is referred to as a device color. The common color space profile is an ICC profile used for color conversion from a device-independent color space to a rendering color space. The rendering color space is, for example, an sRGB, Adobe RGB, or Display P3 color space.

An example of the color conversion processing executed by the CMS 151 is as described below. The CMS 151 sequentially performs the following color conversion processing on the input image data IMi.
(1) A first color conversion CC1 from the input color space to the device-independent space, using the input profile IPF.
(2) A second color conversion CC2 from the device-independent color space to the device-dependent color space for the printing device 400, using the media profile MPF.
(3) A third color conversion CC3 from the device-dependent color space for the printing device 400 to the device-independent color space, using the media profile MPF.
(4) A fourth color conversion CC4 from the device-independent color space to the rendering color space, using the common color space profile CPF.

By the first color conversion CC1 and the second color conversion CC2, the color value of the image data is converted into a range that can be expressed by printing. In other words, by the first color conversion CC1 and the second color conversion CC2, the color value of the image data is converted into a color value in the color space depending on the printing device and the print medium. The image data subjected to the first color conversion CC1 and the second color conversion CC2 is referred to as device color image data IMd. The device color image data IMd is transmitted to the print data generation unit 170 (see FIG. 6). For example, since an image is printed on each of the two sides of the print medium PM, a plurality of pieces of input image data IMi may be input. In this case, a plurality of pieces of device color image data IMd are acquired by the color conversion processing for each input image data IMi.

As shown in FIG. 8, by the third color conversion CC3 and the fourth color conversion CC4, the color value of the image data is converted into a range that can be expressed by rendering. As the first to fourth color conversions CC1 to CC4 are performed, the color value of the image data is converted into a color value in the rendering color space. The image data converted into the color value in the rendering color space is referred to as image data for rendering IMm. The image data for rendering IMm is used as a texture added to a polygon representing the color layer CL in rendering. The RGBA values of the base color of the color layer CL are set to be (1, 1, 1, 1). The image data for rendering IMm is transmitted to the rendering unit 160. Also, for example, since an image is printed on each of the two sides of the print medium PM, a plurality of pieces of input image data IMi may be input. In this case, a plurality of pieces of image data for rendering IMm are acquired by the color conversion processing for each input image data IMi.

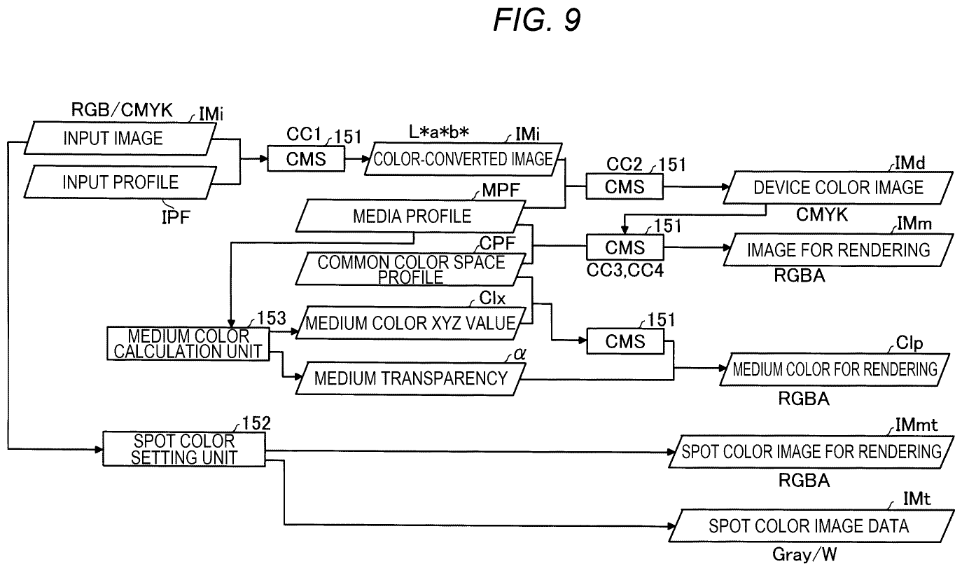

FIG. 9 is a diagram illustrating the flow of the color conversion processing. Although a plurality of CMSs 151 are illustrated in FIG. 9 for the sake of convenience of description, these are the same CMSs 151.

The spot color setting unit 152 generates spot color image data IMt and spot color image data for rendering IMmt. The spot color image data IMt is image data for printing the foundation layer WL. The spot color image data for rendering IMmt is image data formed by converting the spot color image data IMt into a color value in the rendering color space. As shown in FIGS. 2 and 3, when the foundation layer WL is not formed, the generation of the spot color image data IMt and the spot color image data for rendering IMmt is unnecessary.

For example, as shown in FIG. 5, when the foundation layer WL is formed in a range broader than the color layer CL, the spot color setting unit 152 first determines an area occupied by an image, which is an area where printing is performed with the process ink, based on the value of each pixel of the input image data IMi. The area occupied by the image to be printed means an area formed by pixels having a substantial color, that is, pixels that do not satisfy R=G=B=1. The spot color setting unit 152 performs dilation processing on the front-surface image SG and thus generates the spot color image data IMt. The spot color image data IMt represents an area where printing is performed with the foundation ink in order to form the foundation layer WL. The spot color image data IMt is used when creating a spot color plate used to print with the foundation ink. The color space of the spot color image data IMt is the device-dependent color space for the printing device 400. The spot color image data IMt is a grayscale image in the single color of white. The spot color image data IMt is transmitted to the print data generation unit 170. As illustrated in FIG. 4, when the foundation layer WL is formed over substantially the entire back surface of the print medium PM, the spot color setting unit 152 generates the spot color image data IMt indicating that the foundation layer WL is formed on the entire back surface.

The spot color setting unit 152 converts the spot color image data IMt into an image for rendering and thus generates the spot color image data for rendering IMmt. The spot color image data for rendering IMmt is used as a texture added to a polygon representing the foundation layer WL in rendering. In the present embodiment, since the white ink is used to print the foundation layer WL, the spot color setting unit 152 sets, for example, (1, 1, 1, 1) as the RGBA values of the base color of the foundation layer WL. The spot color image data for rendering IMmt is transmitted to the rendering unit 160.

As illustrated in FIG. 9, the medium color calculation unit 153 acquires the YXZ value representing the color of the print medium PM from the media profile MPF. The XYZ values representing the color of the print medium PM are stored in advance in the media profile MPF. The CMS 151 converts XYZ values Clx representing the color of the print medium PM into RGB values, using the common color space profile CPF. Also, the medium color calculation unit 153 acquires a medium transmittance α representing the light transmittance (transparency) of the print medium. The medium transmittance is included in the medium parameters acquired by the parameter acquisition unit 140. The medium color calculation unit 153 combines the RGB values acquired by converting the XYZ values Clx representing the color of the print medium PM with the medium transmittance α to obtain the RGBA values representing the medium color for rendering Clp, and outputs the RGBA values to the rendering unit 160.

The rendering unit 160 generates a rendered image representing how the print medium with the image printed thereon looks in the virtual space. In rendering, the printed object is represented as a 3D object in the virtual space.

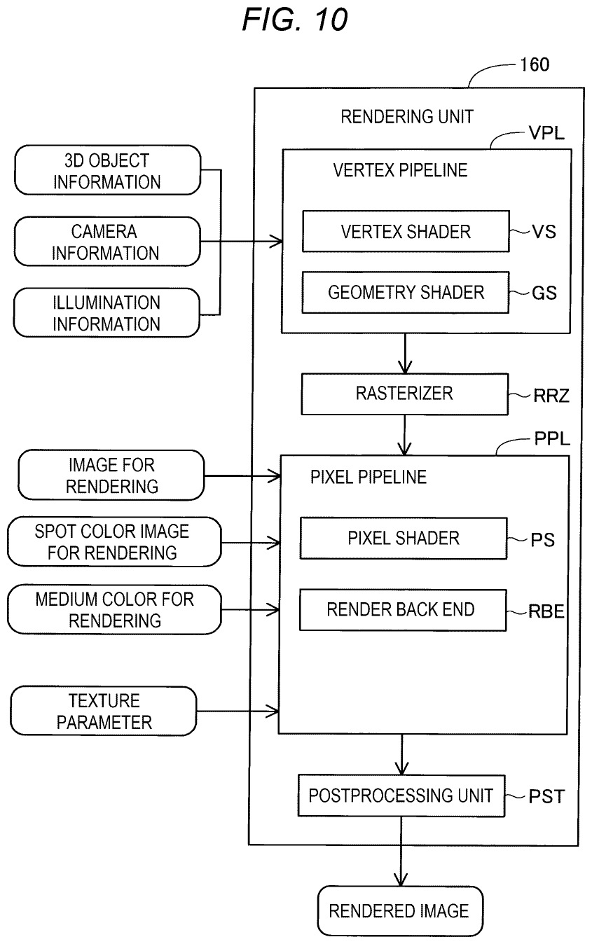

FIG. 10 is a diagram illustrating a configuration of the rendering unit 160. The rendering unit 160 employs a pipeline configuration including a vertex pipeline VPL, a rasterizer RRZ, a pixel pipeline PPL, and a postprocessing unit. The vertex pipeline VPL includes a vertex shader VS and a geometry shader GS. The pixel pipeline PPL includes a pixel shader PS and a render back end RBE.

The vertex shader VS executes processing related to polygons forming the 3D object, using the 3D object information, the camera information, and the illumination information. This processing includes coordinate transformation of the vertices of each polygon forming the 3D object, calculation of a normal vector of each polygon, shading processing, calculation of texture mapping coordinates (UV coordinates), and the like. The coordinate transformation includes model transformation, which is coordinate transformation from the local coordinate system of the 3D object to the world coordinate system, view transformation, which is coordinate transformation from the world coordinate system to the view coordinate system, and projection transformation, which is coordinate transformation from the view coordinate system to the screen coordinate system. A part of the above coordinate transformations may be performed by the geometry shader GS. The result of processing by the vertex shader VS is transmitted to the geometry shader GS.

The geometry shader GS processes a set of vertices of the 3D object. The geometry shader GS increases or decreases the number of vertices and thus can convert a polygon into a point and a line or can convert a point or a line into a polygon. The result of processing by the geometry shaper GS is transmitted to the rasterizer RRZ. The geometry shader GS may not be provided in the rendering unit 160. In this case, the result of processing by the vertex shader VS is transmitted to the rasterizer RRZ.

The rasterizer RRZ executes the rasterization processing and thus generates drawing information for each pixel from the result of processing by the vertex pipeline VPL. The result of processing by the rasterizer RRZ is transmitted to the pixel shader PS.

The pixel shader PS executes lighting processing using the rasterized 3D object, the image data, and the texture parameter, and thus calculates the colors of the front-surface polygon and the back-surface polygon corresponding to each pixel. As a function for calculating the reflection of light in the lighting processing, for example, Disney bidirectional reflection distribution function (BRDF) can be used. The result of processing by the pixel shader PS is transmitted to the render back end RBE.

The render back end RBE determines whether to write the pixel data generated by the pixel shader PS into the display area in the memory 101. When the render back end RBE determines that the pixel data is to be written in the memory 101, the pixel data is saved as a drawing target, whereas when the render back end RBE does not determine that the pixel data is to be written in the memory 101, the pixel data is not saved as a drawing target. To determine whether to write the pixel data, for example, an alpha test, a depth test, a stencil test, or the like is used. In the present embodiment, the pixel data includes color information of the front-surface polygon and color information of the back-surface polygon. The render back end RBE writes colors in order from the color of the polygon object on the rear side in relation to the camera, for example, by a depth sorting method. When writing the color of the polygon on the fore side after writing the color of the polygon object on the rear side, the render back end RBE combines the color of the polygon on the rear side and the color of the polygon on the fore side according to the transmittance of the polygon on the fore side, for example, by alpha blending. In the case where the transmittance is zero, when the color of the polygon on the fore side is written, the color of the polygon on the rear side is overwritten with the color of the polygon on the fore side. Such processing of writing in the display area is also referred to as “drawing processing”. As the pixel data is written into the memory 101, the pipeline processing ends.

The postprocessing unit PST executes the postprocessing of the processing of, for example, antialiasing, ambient occlusion, screen space reflection, and depth of field, on the rendered image made up of the pixel data saved in the memory 101. The postprocessing improves the appearance of the rendered image.

The print data generation unit 170 generates print data to be supplied to the printing device 400. The print data generation unit 170 includes a setting unit 171, a separation unit 173, and a halftone processing unit 175.

The setting unit 171 determines whether the left-right reversal processing of the image to be printed is required according to the print condition. Specifically, when “back printing” is selected as the type of printing, the setting unit 171 determines that the left-right reversal processing is required for the image to be printed. When “front printing” is selected as the type of printing, the setting unit 171 determines that the left-right reversal processing is not required for the image to be printed.

When the left-right reversal processing is necessary, that is, when back printing is designated, the setting unit 171 executes the left-right reversal processing of the device color image data IMd obtained by the color conversion processing by the CMS 151. Meanwhile, when front printing is designated, the reversal processing is not executed.

The setting unit 171 determines the order in which print layers are stacked. Specifically, the arrangement position (arrangement surface) at which the print layers are arranged on the print medium and the stacking order in which a plurality of print layers are stacked when the number of print layers is a plurality are determined according to the print condition. When “YES” is selected for the presence of the foundation layer, the number of print layers is two, that is, the color layer and the foundation layer. When “NO” is selected for the presence of the foundation layer, the number of print layers is one, that is, the color layer. When “back printing” is selected as the type of printing, the arrangement position of each layer is the back surface of the print medium. When “front printing” is selected as the type of printing, the arrangement position of each layer is the front surface of the print medium.

For example, when “back printing” is selected as the type of printing and “YES” is selected for the presence of the foundation layer, it is determined that the color layer and the foundation layer are stacked in this order on the back surface of the print medium. When “front printing” is selected as the type of printing and “YES” is selected for the presence of the foundation layer, it is determined that the foundation layer and the color layer are stacked in this order on the front surface of the print medium.

The separation unit 173 converts the output value of each pixel of the device color image data IMd subjected to the left-right reversal processing or not subjected to the left-right reversal processing, into the density value of a plurality of color materials of the printing device 400. In the present embodiment, the separation unit 173 converts the output values CMYK of each pixel of the device color image data IMd into the density value of each color of the process ink. Also, the separation unit 173 converts the output value of each pixel of the spot color image data IMt into the density value of the foundation ink. With the processing by the separation unit 173, each of CMYKLcLm plates and a spot color plate are generated. When printing is performed on both sides of the print medium PM, the separation unit 173 generates each of CMYKLcLm plates and a spot color plate for each of the front surface and the back surface of the print medium PM.

The halftone processing unit 175 performs halftone processing using the density value of each pixel after separation, and thus generates print data. The printing device 400 receives the print data transmitted from the halftone processing unit 175, and executes printing, based on the print condition included in the received print data. When printing is performed on both surfaces of the print medium PM, the halftone processing unit 175 generates print data for each of the front surface and the back surface of the print medium PM.

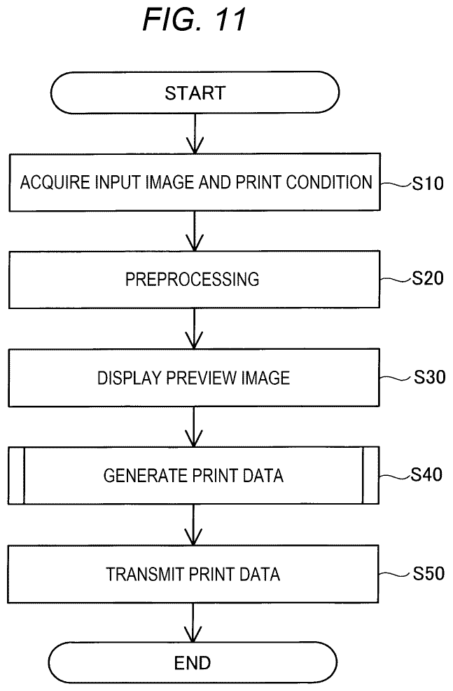

FIG. 11 is a flowchart showing printing processing executed in the image processing device 100. The processing shown in FIG. 11 is started, for example, when an operation instruction is accepted via the input device 200 of the user.

In step S10, the input image data IMi and the print condition are acquired. Specifically, first, the user interface UI (see FIG. 7) is displayed on the display device 300. Also, the image data (input image data IMi) designated by the user via the user interface UI is acquired. Moreover, information representing the print condition input by the user via the user interface UI is acquired. In the example shown in FIG. 7, the type of printing, whether the foundation layer is present, and the range of the foundation layer can be designated as the print conditions. The processing of step S10 is executed by the processor 103 functioning as the image data acquisition unit 110 and the print condition acquisition unit 130.

In step S20, preprocessing is executed by each unit of the preprocessing unit 150. The contents of the preprocessing are as shown in FIG. 9. In the preprocessing, the device color image data IMd, the spot color image data IMt, the image data for rendering IMm, the spot color image data for rendering IMmt, and the medium color for rendering Clp are generated. The device color image data IMd and the spot color image data IMt are transmitted to the print data generation unit 170. The image data for rendering IMm, the spot color image data for rendering IMmt, and the medium color for rendering Clp are transmitted to the rendering unit 160.

In step S30, the rendered image generated by the rendering unit 160 is displayed as a preview image on the display device 300. The processing by the rendering unit 160 is as shown in FIG. 10. In step S40, the print data is generated by the print data generation unit 170. Details of the processing of step S40 will be described later. In step S50, the print data is transmitted to the printing device 400. In this way, a series of processing related to the printing is executed in the image processing device 100.

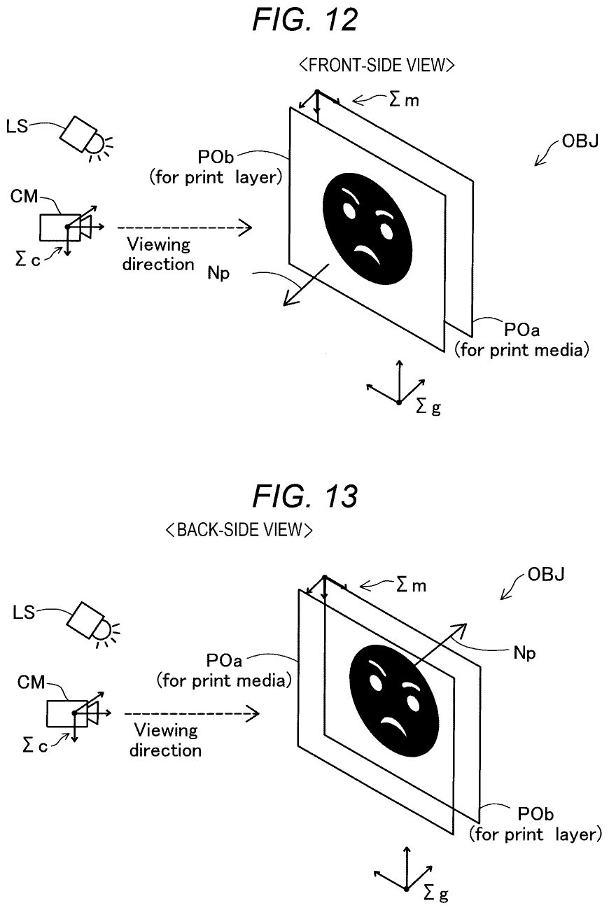

In the present embodiment, the image processing device 100 displays a rendered image as a preview image. FIG. 12 is a diagram schematically illustrating a state where the front surface of a printed object represented as a 3D object in a virtual space is observed. FIG. 13 is a diagram schematically illustrating a state where the back surface of the printed object represented as a 3D object in the virtual space is observed. Here, an example of a printed object in which printing is performed on the front surface of the print medium PM as shown in FIG. 2 is described. The printed object is expressed as a 3D object OBJ (3-Dimensional Object). The 3D object OBJ includes a polygon object POa for rendering related to the print medium PM and a polygon object POb for rendering related to the print layer.

The two polygon objects POa and POb are arranged in parallel. The direction of a normal vector Np of the polygon object POa is on the front surface side of the 3D object OBJ. The 3D object OBJ is illuminated by a light source LS. In FIGS. 12 and 13, the line of sight of a camera CM is indicated by a dashed arrow. In the rendering processing, the 3D object OBJ is handled as a transparent object. In FIGS. 12 and 13, for the sake of convenience, a long distance is drawn between the two polygon objects POa and POb, but in practice, the distance between the polygon objects POa and POb in the virtual space is set to be a very short distance that does not cause the generation of Z-fighting. In the virtual space, the thickness of the polygon object POa representing the print medium PM reflects the thickness of the print medium PM, and the thickness of the polygon object POb representing the print layer is substantially zero.

In FIGS. 12 and 13, a local coordinate system Σm (also referred to as a model coordinate system), which is the three-dimensional orthogonal coordinate system of the 3D object OBJ, a world coordinate system Σg (also referred to as a global coordinate system), which is the three-dimensional orthogonal coordinate system of the virtual space, and a view coordinate system Σc (also referred to as a camera coordinate system), which is the three-dimensional orthogonal coordinate system of the camera CM arranged in the virtual space, are drawn as the coordinate systems used for the rendering processing. In the rendering processing, another coordinate system such as a screen coordinate system, which is the coordinate system of a screen on which a scene viewed from the camera CM is projected, is also used, but this is not illustrated in FIGS. 12 and 13.

As shown in FIG. 12, in the state where the line-of-sight direction of the camera CM faces the front side of the 3D object OBJ, a front-side view acquired by observing the front side of the 3D object OBJ through the camera CM is generated as a rendered image.

As shown in FIG. 13, in the state where the back side of the 3D object OBJ faces the line-of-sight direction of the camera CM, a back-side view acquired by observing the back side of the 3D object OBJ through the camera CM is generated as a rendered image.

Each of the polygon objects POa and POb may be formed of one polygon. Alternatively, each of the polygon objects POa and POb may be formed of a plurality of small polygons. When the polygon object is formed of a plurality of polygons, not only a rendered image of a planar printed object but also a rendered image of a curved printed object can be easily generated.

The display device 300 displays, for example, a preview image representing the state of the front surface of the printed object and a preview image representing the state of the back surface of the printed object, as shown at the bottom in FIGS. 2 to 5. Thus, the user can easily check the state of the front surface and the state of the back surface of the printed object printed on the transparent print medium PM.

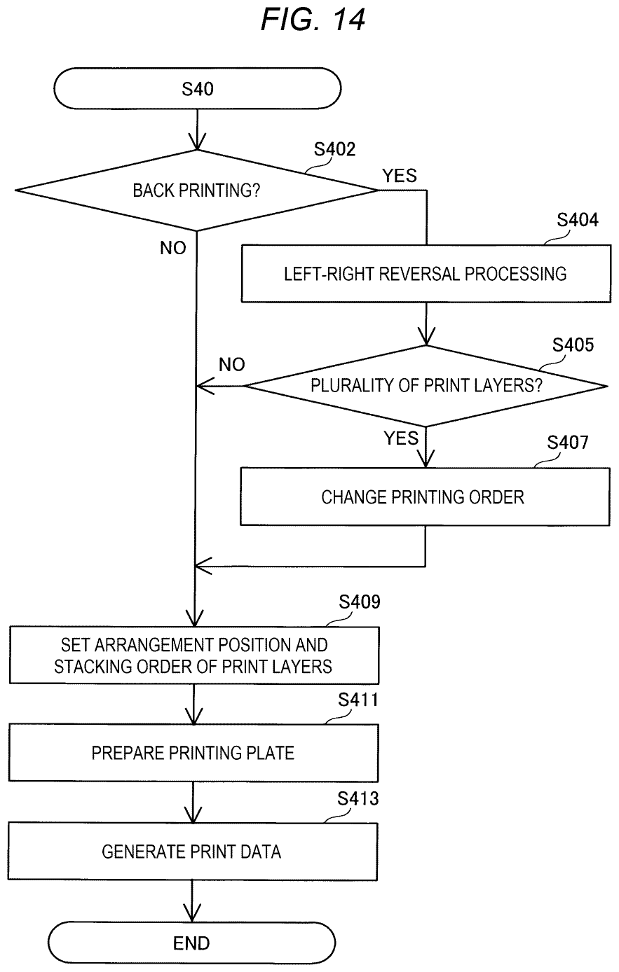

FIG. 14 is a flowchart of the processing of generating the print data in step S40 in FIG. 11. In step S402, the setting unit 171 determines whether back printing is designated. When the setting unit 171 determines that back printing is designated (YES in step S402), the processing of step S404 is executed. When the setting unit 171 determines that back printing is not designated (NO in step S402), the processing of step S409 is executed.

In step S404, the setting unit 171 executes the left-right reversal processing of the image. When the device color image data IMd and the spot color image data IMt are supplied from the preprocessing unit 150, the setting unit 171 executes the left-right reversal processing on each of the device color image data IMd and the spot color image data IMt. When only the device color image data IMd is supplied from the preprocessing unit 150, the setting unit 171 executes the left-right reversal processing on the device color image data IMd. The left-right reversed image data is stored in the memory 101.

In step S405, the setting unit 171 determines whether stacking of a plurality of print layers is designated. For example, when “YES” is selected for the presence of the foundation layer”, the number of print layers is two, that is, the color layer and the foundation layer. When stacking of a plurality of print layers is designated (YES in step S405), the processing of step S407 is executed. When stacking of a plurality of print layers is not designated (NO in step S405), the processing of step S409 is executed.

In step S407, the setting unit 171 changes the stacking order. In the case of front printing, the foundation layer and the color layer are stacked in this order on the front surface of the print medium. In the case of back printing, the color layer and the foundation layer are stacked in this order on the back surface of the print medium.

In step S409, the setting unit 171 sets an arrangement position (arrangement surface) at which the print layers are arranged on the print medium and a stacking order in which a plurality of print layers are stacked when the number of print layers is a plurality. The setting unit 171 stores data representing the arrangement position and the stacking order in the memory 101.

When the print condition indicates back printing and the presence of the foundation layer, for example, data such as “arrangement position (arrangement surface): back, stacking order: medium+color layer+foundation layer” is output. When the print condition indicates front printing and the presence of the foundation layer, for example, data such as “arrangement position (arrangement surface): front, stacking order: medium+foundation layer+color layer” is output.

In step S411, the separation unit 173 creates each of CMYKLcLm plates and a spot color plate to be used when necessary. In step S413, the halftone processing unit 175 performs halftone processing and thus generates print data. When the generated print data is transmitted to the printing device 400, the printing device 400 executes printing.

According to the related art, the user needs to designate a stacking order of layers and prepare a left-right reversed image. If the user makes a mistake in designating the stacking order of the color layer and the foundation layer, printing needs to be redone. When a print medium formed of a material such as acrylic or glass is used, as compared with a print medium formed of paper, the cost tends to increase as the number of times of redoing printing increases. In the present embodiment, when printing the foundation layer and the color layer, the image processing device 100 determines the stacking order according to the position on the medium (the surface of the medium) where the foundation layer and the color layer are arranged. Also, when back printing is designated, the image processing device 100 executes the left-right reversal processing of the image. Therefore, the occurrence of human errors by the user can be suppressed. Since the image processing device 100 displays the preview images of the front surface and the back surface of the printed object on the display device 300, the user can check the finished state of the printed object before executing printing. Thus, operability in printing is improved. As a result, usability is improved.

### B. Second Embodiment

In the first embodiment, an example in which one color layer is formed on the print medium is described. In a second embodiment, an example of a printed object in which two or more color layers are formed will be described. In the description below, configurations different from those of the first embodiment will be mainly described, and descriptions of configurations similar to those of the first embodiment will be omitted.

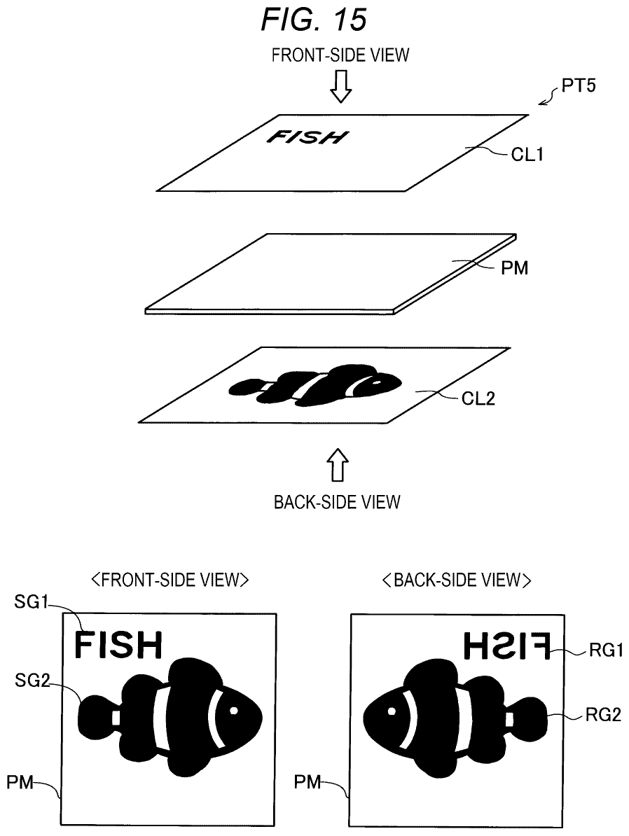

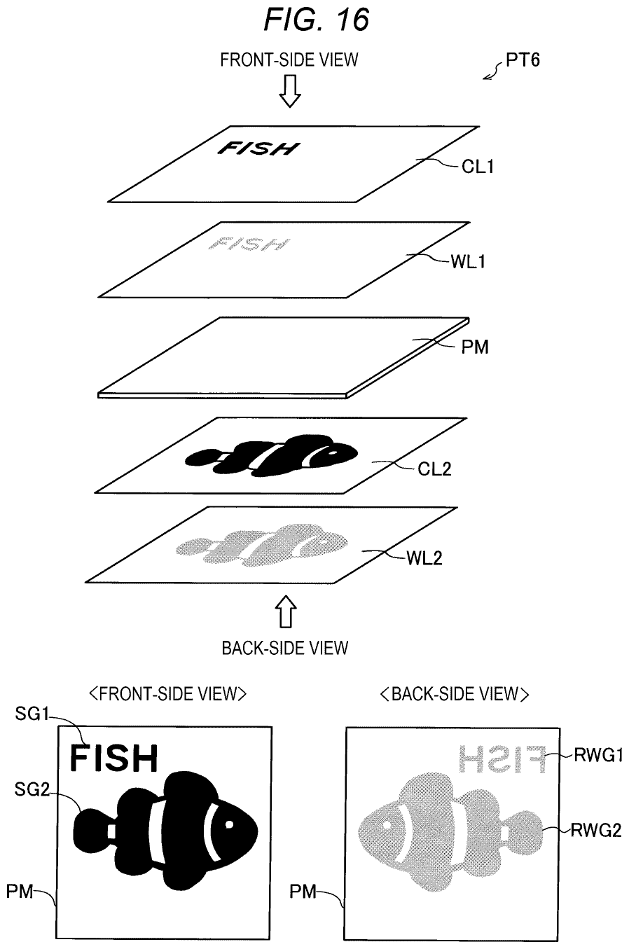

FIG. 15 is a diagram illustrating a printed object PT5, which is an example of a printed object in which an image is printed on both sides of a transparent print medium. The top part of FIG. 15 shows the positional relationship between the print medium PM, a color layer CL1, and a color layer CL2. The bottom part of FIG. 15 shows a preview image of the printed object PT5 displayed on the display device 300 by the image processing device 100. The same applies to FIGS. 16 to 18 described below. In FIG. 15, for the sake of convenience, the color layer CL1 and the color layer CL2 are represented by frames having a size similar to that of the print medium PM. The actual color layer CL1 is formed of only an image part inside the frame. The same applies to the color layer CL2.

In the printed object PT5, an image is printed on both sides of the print medium PM. Specifically, in the printed object PT5, the color layer CL1 forming a front-surface image SG1 is formed with the process ink on the front surface of the transparent print medium PM. That is, the color layer CL1 is formed by front printing. Also, the color layer CL2 forming a back-surface image RG2 is formed on the back surface of the print medium PM. That is, the color layer CL2 forming the back-surface image RG2 is formed by back printing.

It is assumed that the printed object PT5 is to be observed only from the front surface side. When observed from the back surface side, a back-surface image RG1, which is the left-right reversed image of the front-surface image SG1, is seen. When observed from the front surface side, a front-surface image SG2, which is the left-right reversed image of the back-surface image RG2, is seen.

FIG. 16 is a diagram illustrating a printed object PT6. In the printed object PT6, an image is printed on both sides of the transparent print medium PM. A foundation layer WL1 formed of the foundation ink and a color layer CL1 are stacked on the front surface of the print medium PM in this order from the side closer to the front surface of the print medium PM. The color layer CL1 and the foundation layer WL1 are formed by front printing. A color layer CL2 and a foundation layer WL2 are stacked on the back surface of the print medium PM in this order from the side closer to the back surface of the print medium PM. The color layer CL2 and the foundation layer WL2 are formed by back printing.

The foundation layer WL1 is the foundation of the color layer CL1. The foundation layer WL1 is formed in the same shape as a front-surface image SG1 formed by the color layer CL1. The foundation layer WL2 is the foundation of the color layer CL2. The foundation layer WL2 is formed in the same shape as a front-surface image SG2 formed by the color layer CL2.

It is assumed that the printed object PT6 is to be observed only from the front surface side. When observed from the front surface side, the front-surface image SG1 and the front-surface image SG2 are seen. When observed from the back surface side, a foundation area RWG1 and a foundation area RWG2 are seen. The foundation area RWG1 has a shape corresponding to the left-right reversed image of the front-surface image SG1 and is formed by the foundation layer WL1. The foundation area RWG2 has a shape corresponding to the left-right reversed image of the front-surface image SG2 and is formed by the foundation layer WL2.

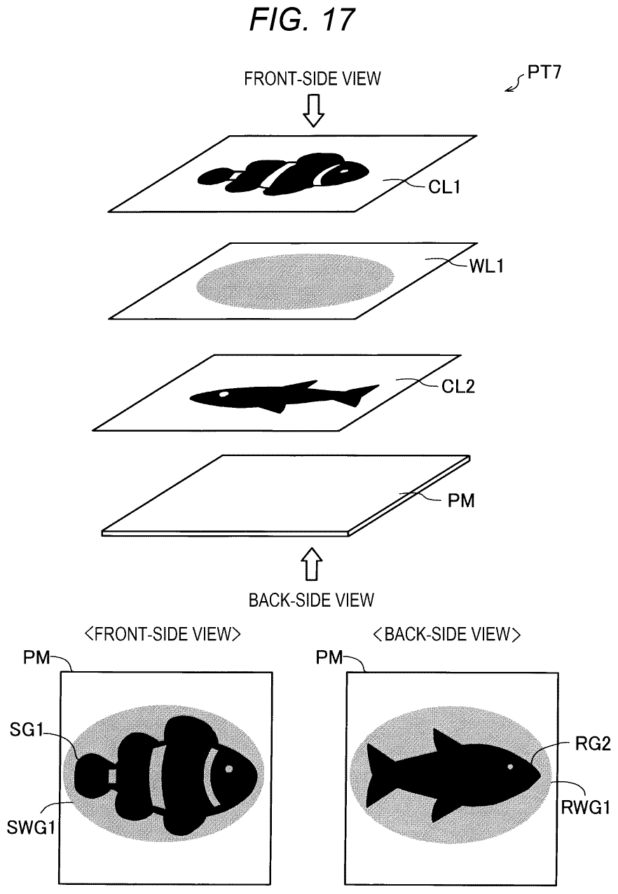

FIG. 17 is a diagram illustrating a printed object PT7. In the printed object PT7, an image is printed on one side of the transparent print medium PM. A color layer CL2, a foundation layer WL1, and a color layer CL1 are stacked on the front surface of the print medium PM in this order from the side closer to the front surface of the print medium PM. In the printed object PT7, all the layers are formed by front printing.

The foundation layer WL1 is the foundation of the color layer CL1 and the color layer CL2. In FIG. 17, the foundation layer WL1 is formed in an elliptical shape completely including a front-surface image SG1 formed by the color layer CL1 and a back-surface image RG2 formed by the color layer CL2.

It is assumed that the printed object PT7 is to be observed from the front surface side and the back surface side. When observed from the front surface side, the front-surface image SG1 and a foundation area SWG1 are seen. The foundation area SWG1 is formed by the foundation layer WL1. When observed from the back surface side, the back-surface image RG2 and a foundation area RWG1 are seen. The foundation area RWG1 is formed by the foundation layer WL1. The back-surface image RG2 is invisible from the front surface side, and the front-surface image SG1 is invisible from the back surface side.

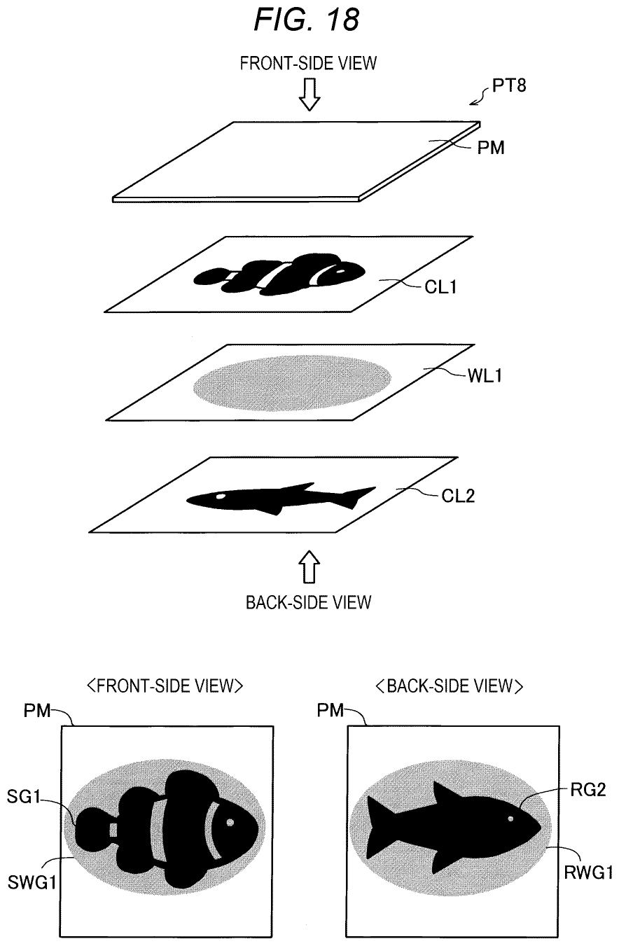

FIG. 18 is a diagram illustrating a printed object PT8. In the printed object PT7 shown in FIG. 17, all the layers are formed on the front surface of the print medium PM by front printing, whereas in the printed object PT8 shown in FIG. 18, all the layers are formed on the back surface of the print medium PM by back printing. A color layer CL1, a foundation layer WL1, and a color layer CL2 are stacked on the back surface of the print medium PM in this order from the side closer to the back surface of the print medium PM.

The foundation layer WL1 is the foundation of the color layer CL1 and the color layer CL2. In FIG. 18, the foundation layer WL1 is formed in an elliptical shape completely including a front-surface image SG1 formed by the color layer CL1 and a back-surface image RG2 formed by the color layer CL2.

It is assumed that the printed object PT8 is to be observed from the front surface side and the back surface side. When observed from the front surface side, the front-surface image SG1 and a foundation area SWG1 are seen. The foundation area SWG1 is formed by the foundation layer WL1. When observed from the back surface side, the back-surface image RG2 and a foundation area RWG1 are seen. The foundation area RWG1 is formed by the foundation layer WL1. The back-surface image RG2 is invisible from the front surface side, and the front-surface image SG1 is invisible from the back surface side. The printed object PT8 illustrated in FIG. 18 and the printed object PT7 illustrated in FIG. 17 are similar in that the front-surface image SG1 representing a clownfish is seen from the front surface side and that the back-surface image RG2 representing a shark is seen from the back surface side. However, since the surface on which the print layer is formed is different between the printed object PT7 and the printed object PT8, in the printed object PT7, the back-surface image RG2 representing a shark is seen through the print medium PM, whereas in the printed object PT8, the front-surface image SG1 representing a clownfish is seen through the print medium PM.

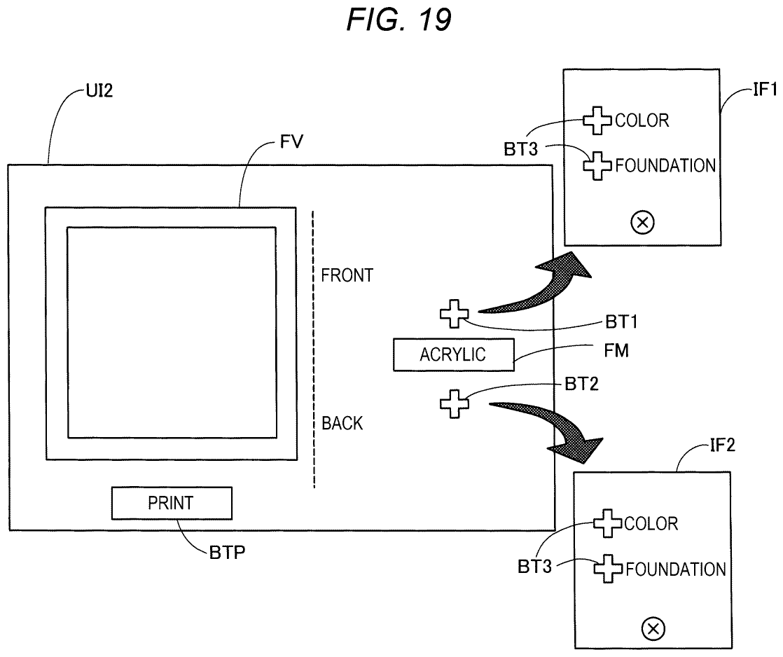

FIG. 19 is a diagram illustrating an example of a user interface UI2 for inputting image data. The user interface UI2 is displayed on the display device 300 under the control of the processor 103. An example in which an acrylic plate is used as the print medium PM will be described.

The user interface UI2 is provided with a display area FM for displaying the type of the print medium PM, a button BT1 for adding a print layer to be stacked on the front surface of the print medium PM, a button BT2 for adding a print layer to be stacked on the back surface of the print medium PM, a display area FV for displaying a preview image, and a print button BTP for giving an instruction to start printing.

When the user taps the button BT1, an input form IF1 is displayed. The input form IF1 is used to add a print layer to be arranged on the front surface of the acrylic plate as the print medium PM. In the input form IF1, a color layer and a foundation layer can be selected. The user can add a desired print layer by tapping a button BT3.

When the user taps the button BT2, an input form IF2 is displayed. The input form IF2 is used to add a print layer to be arranged on the back surface of the acrylic plate as the print medium PM. In the input form IF2, a color layer and a foundation layer can be selected. The user can add a desired print layer by tapping a button BT3.

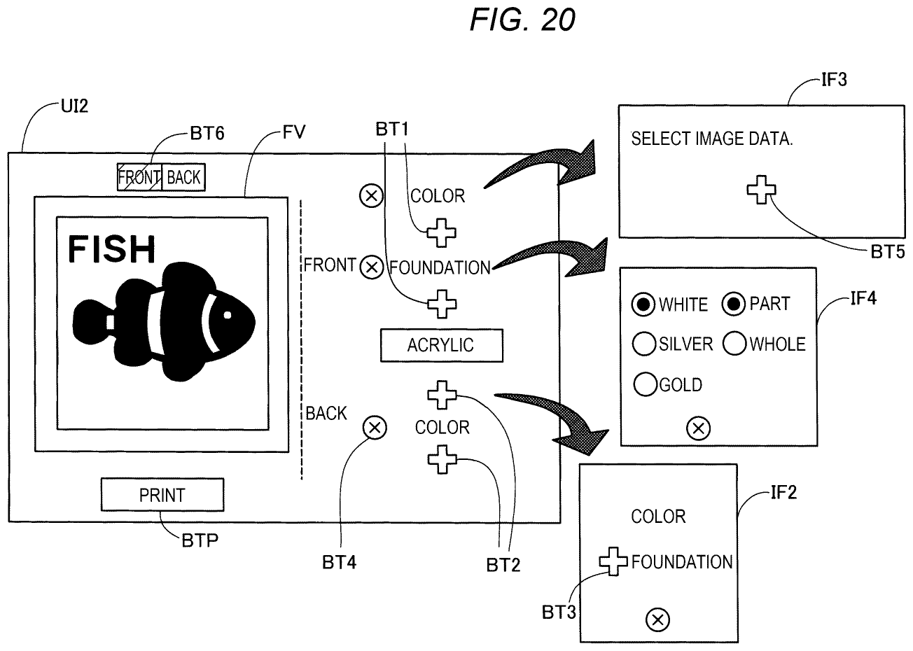

FIG. 20 is a diagram illustrating an input operation on the user interface UI2. FIG. 20 illustrates the user interface UI2 representing the state after the user adds some print layers. In the example illustrated in FIG. 20, a foundation layer and a color layer are added to the front surface of the acrylic plate as print medium PM. A color layer is added to the back surface of the acrylic plate.

On the user interface UI2, buttons BT1 and BT2 for adding other print layers are displayed above and below the print layer added by the user. Also, a button BT4 for deleting each print layer added by the user is displayed on the user interface UI2. The user can tap the button BT4 and thus can delete the added print layer.

For example, when the user taps the button BT2 between the acrylic plate and the color layer on the back surface in the state shown in FIG. 20, an input form IF2 is displayed. In this case, only the foundation layer can be selected in the input form IF2. This is because it is not preferable to stack the color layer on another color layer. Thus, the user can be prevented from erroneously stacking two or more color layers.

When the user taps the added color layer, an input form IF3 for inputting image data is displayed. The user can tap a button BT5 in the input form IF3 and thus can select, for example, image data stored in advance in the memory 101 of the image processing device 100. When image data is selected for the added color layer, a preview image is displayed in the display area FV. As an initial setting, a preview image representing the front surface of the printed object is displayed in the display area FV. Also, a button BT6 for switching the display of the preview image is displayed above the display area FV. The user taps the button BT6 and thus gives an instruction to display, in the display area FV, a preview image that is different from the currently displayed preview image, of the preview image representing the front surface of the printed object and the preview image representing the back surface. Upon receiving an operation instruction from the user via the button BT6, the rendering unit 160 updates the display of the rendered image displayed in the display area FV. As a result, the display of the preview image is switched.

When the user taps the added foundation layer, an input form IF4 for selecting the color of the foundation ink is displayed. The user can select the color of the foundation ink in the input form IF4. In the illustrated example, “white”, “silver”, or “gold” can be selected as the foundation ink. Moreover, the user can select “part” or “whole” as the range for printing the foundation ink in the input form IF4. When “part” is selected as the range for printing the foundation ink, the foundation layer is formed corresponding to the range of the image formed by the color layer. When “whole” is selected as the range for printing the foundation ink, the foundation layer is formed in a predetermined range including the image formed by the color layer.

In the present embodiment, the image data acquisition unit 110 acquires the image data of the image selected via the user interface UI2 for each color layer. When two color layers are added via the user interface UI2, the input image data IMi is acquired for each color layer. The one or a plurality of input image data IMi are transmitted to the preprocessing unit 150.

The print condition acquisition unit 130 acquires a print condition. The print condition includes conditions such as the type of print medium, the type of printing, the number of print layers, the type of ink of each print layer, the resolution of printing, the type of the printing device, and whether the printing is single-sided printing or double-sided printing. In the present embodiment, the print condition further includes the stacking order of one or a plurality of color layers and one or a plurality of foundation layers stacked on the front surface of the print medium, the stacking order of one or a plurality of color layers and one or a plurality of foundation layers stacked on the back surface of the print medium, and the color of each foundation layer.

In the example illustrated in FIG. 16, the spot color setting unit 152 generates the spot color image data IMmt for rendering for the foundation layer WL1, using the input image data IMi corresponding to the color layer CL1. The spot color setting unit 152 generates the spot color image data IMmt for rendering for the foundation layer WL2, using the input image data IMi corresponding to the color layer CL2. The spot color setting unit 152 executes the left-right reversal processing of the image represented by the input image data IMi when necessary. For example, in the example shown in FIG. 16, in order to acquire the foundation area RWG1 and the foundation area RWG2, which can be seen from the back surface, the left-right reversal processing of the corresponding front-surface image is necessary.

The setting unit 171 of the print data generation unit 170 determines the image that needs the left-right reversal processing, in accordance with the arrangement position (arrangement surface) at which the print layer is arranged on the print medium, the number of print layers, whether the foundation layer is present, and the like. When the left-right reversal processing is needed, the setting unit 171 executes the left-right reversal processing on the target device color image data IMd and the target spot color image data IMt.

The setting unit 171 determines the order of stacking the print layers in accordance with the arrangement position (arrangement surface) at which the print layers are arranged on the print medium, the number of print layers, whether the foundation layer is present, and the like.

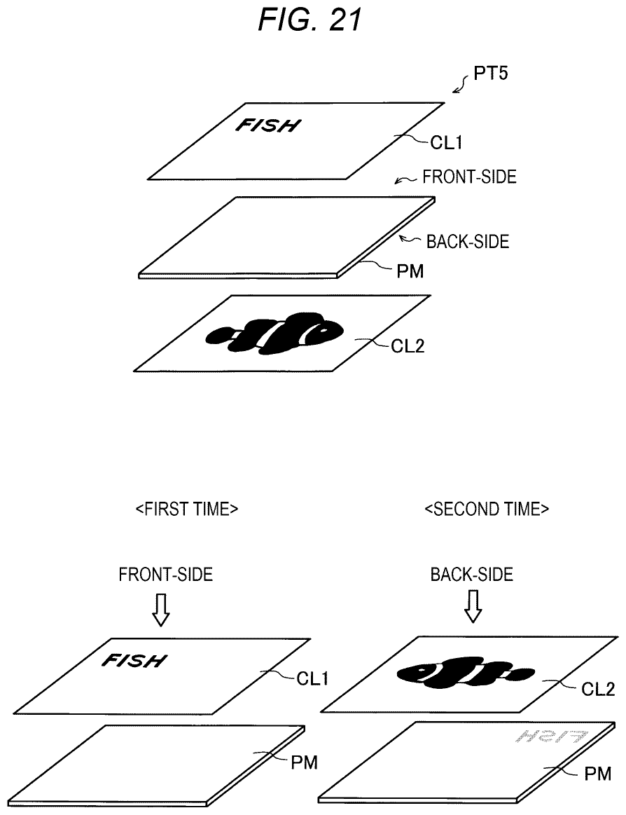

FIG. 21 is a diagram related to a method of printing the printed object PT5 shown in FIG. 15. In this example, printing is divided into two rounds. First, as front printing is performed, the color layer CL1 is thus formed on the front surface of the print medium PM. Next, the directions of the front surface and the back surface of the print medium PM are reversed. Subsequently, as back printing is performed, the color layer CL2 is formed on the back surface of the print medium PM. The left-right reversed image of the input image corresponding to the color layer CL2 is printed as the color layer CL2.

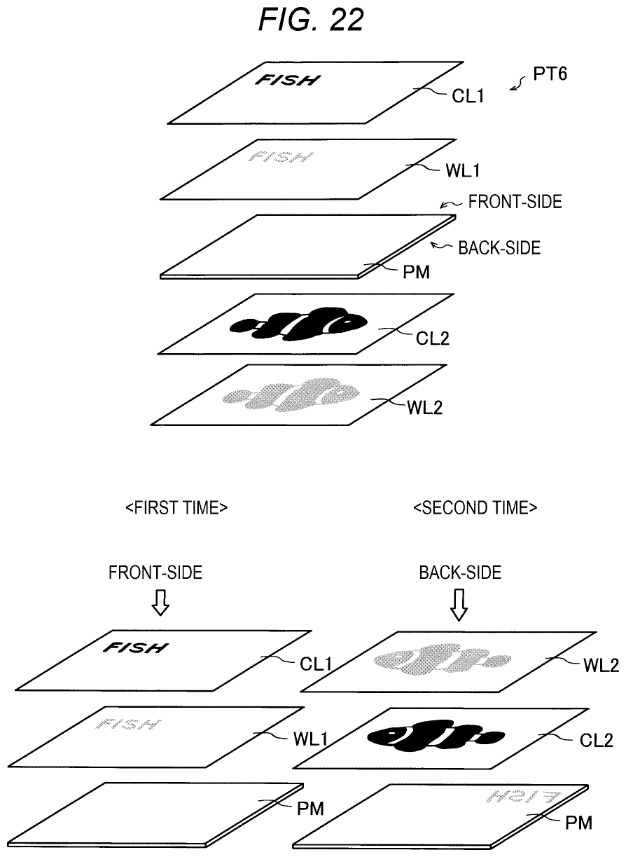

FIG. 22 is a diagram related to a method of printing the printed object PT6 shown in FIG. 16. First, as front printing is performed, the foundation layer WL1 and the color layer CL1 are formed in this order on the front surface of the print medium PM. Next, the directions of the front surface and the back surface of the print medium PM are reversed. Subsequently, as back printing is performed, the color layer CL2 and the foundation layer WL2 are formed in this order on the back surface of the print medium PM. The left-right reversed image of the input image corresponding to the color layer CL2 is printed as the color layer CL2 and the foundation layer WL2.

When printing the printed object PT7 shown in FIG. 17, the color layer CL2, the foundation layer WL1, and the color layer CL1 are formed in this order on the front surface of the print medium PM by front printing. It is assumed that the color layer CL2 is to be viewed from the back surface. Therefore, the left-right reversed image of the input image corresponding to the color layer CL2 is printed as the color layer CL2.

As described above, in the present embodiment, when the foundation layer and the color layer are printed, the stacking order is determined according to the position on the medium (the surface of the medium) on which the foundation layer and the color layer are arranged. Also, according to the arrangement position (arrangement surface) at which the print layer is arranged on the print medium, the number of print layers, whether the foundation layer is present, and the like, the left-right reversal processing of the image is executed prior to the printing, when necessary. Unlike in the related art, the user does not need to designate the stacking order of the layers or to prepare a left-right reversed image. Thus, operability in printing is improved. As a result, usability is improved.

### C. Third Embodiment

In the first embodiment and the second embodiment, an example in which the print layers includes the color layer formed by printing the process ink and the foundation layer formed by printing the foundation ink is described. Also, the print layers may include a clear layer. The clear layer is formed by printing a clear ink. The clear ink is also referred to as a varnish ink. The clear ink is a kind of spot color ink, but in this example, the print layer formed by the clear ink is referred to as a clear layer, and the print layer formed by the foundation ink is referred to as a foundation layer. As the clear layer is formed on the color layer, the color layer forming an image can be protected. Also, the clear layer can express a texture such as a matte tone or a glossy tone. In the description below, configurations different from those of the first embodiment and the second embodiment will be mainly described, and descriptions of configurations similar to those of the first embodiment and the second embodiment will be omitted.

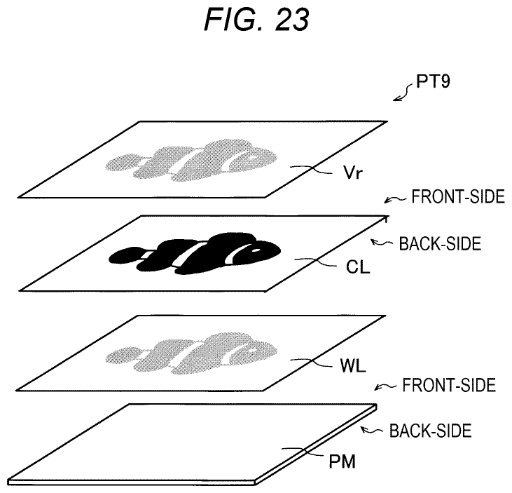

FIG. 23 is a diagram illustrating a printed object PT9. In the printed object PT9, a foundation layer WL, a color layer CL, and a clear layer VL are stacked on the front surface of the print medium PM in this order from the side closer to the front surface of the print medium PM. In the printed object PT9, the clear layer VL is formed only in the range of the image formed by the color layer CL in order to express the texture of the image formed by the color layer CL. The print medium PM may be an opaque print medium.

As in the printed object PT6 illustrated in FIG. 16, a color layer may be formed on each of the front surface and the back surface of the print medium PM. In the printed object PT5, a clear layer may be formed on each of the surfaces of the color layer CL1 and the color layer CL2. In this case, the color layer CL1 and a clear layer (not shown) are formed in this order on the front surface of the transparent print medium PM. The color layer CL2 and a clear layer (not shown) are formed in this order on the back surface of the print medium PM.

The user may be able to designate whether to add a clear layer in the input form IF1 and the input form IF2 of the user interface UI2 shown in FIG. 20. The user may select “part” or “whole” as the range for printing the clear ink, using an input form similar to the input form IF4. When “part” is selected as the range for printing the clear ink, the clear layer is formed corresponding to the range of the image formed by the color layer. When “whole” is selected as the range for printing the clear ink, the clear layer is formed in a predetermined range including the image formed by the color layer.

The spot color setting unit 152 generates clear image data for rendering IMmc. The clear image data for rendering IMmc is used as a texture added to a polygon representing a clear layer in rendering. The spot color setting unit 152 generates the clear image data for rendering IMmc for the clear layer, using the input image data IMi corresponding to the color layer. The method of generating the clear image data for rendering IMmc is similar to the method of generating the spot color image data for rendering IMmt. When the clear layer VL is not formed on one of the front surface and the back surface or not formed on either the front surface or the back surface, the clear image data for rendering IMmc need not be generated. In the present embodiment, the spot color setting unit 152 generates the spot color image data IMt for the foundation layer and the spot color image data IMt for the clear layer.

When the user designates the addition of the clear layer, the setting unit 171 determines that the color layer formed of the process ink and the clear layer formed of the clear ink are stacked on the print medium in this order, when determining the order of stacking the print layers. The user only needs to designate the addition of the clear layer and does not need to designate the stacking order. Thus, the user can easily perform an operation of setting for printing.

### D. Fourth Embodiment

In a fourth embodiment, an example in which transfer printing is executed in the printing system 10 will be described. In the description below, configurations different from those of the first embodiment will be mainly described, and descriptions of configurations similar to those of the first embodiment will be omitted. In the present embodiment, the printing device 400 can perform transfer printing. In the present embodiment, it is assumed that sublimation transfer is used for the transfer printing executed by the printing device 400. Transfer printing refers to a method in which an ink is attached to a recording surface of a transfer paper by printing and in which the recording surface of the transfer paper is pressed against a print medium that is a target of printing, and then heated, thus performing printing on the print medium by heat transfer. As the print medium, a fabric, or a ceramic such as a tile or cup is used.

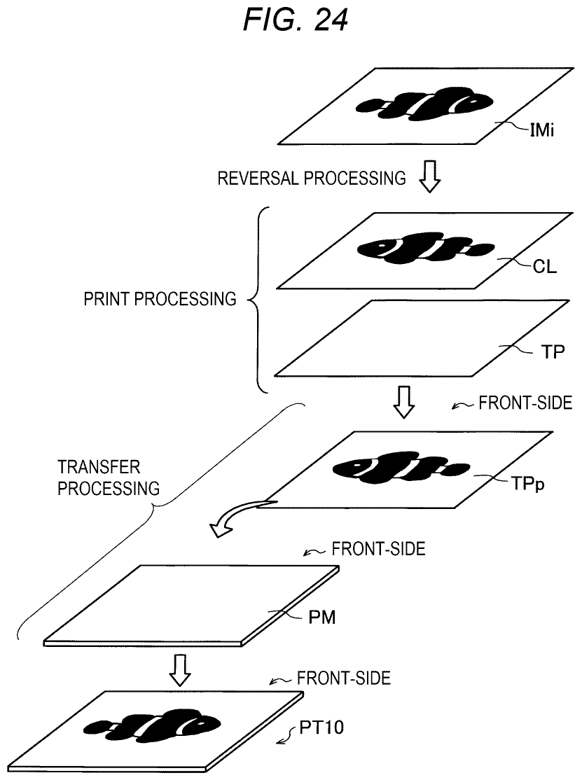

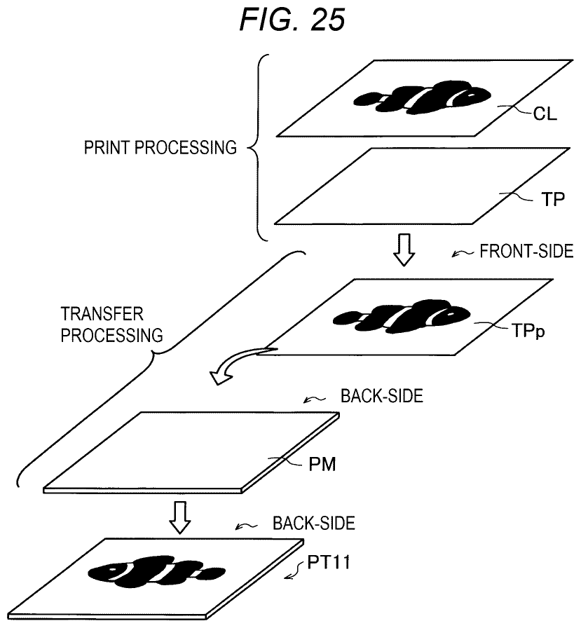

FIGS. 24 and 25 are diagrams illustrating a method of transfer printing. FIG. 24 is a diagram illustrating front printing. In front printing, first, input image data IMi is left-right reversed (reversal processing). The printing device 400 prints a color layer CL representing the left-right reversed image on the front surface of a transfer paper TP (print processing). The front surface of the transfer paper TP is a recording surface of the transfer paper TP. The transfer paper TP on which printing is already performed is referred to as a printed transfer paper TPp. The printed transfer paper TPp is heated in the state where the recording surface of the printed transfer paper TPp is pressed against the front surface of the print medium PM (transfer processing). In the transfer processing, a press machine corresponding to the shape of the print medium is used. For example, when the print medium is a fabric, a flat press machine is used. When the print medium that is a target of printing is cylindrically shaped, a mug press machine is used. As a result, a printed object PT10 is obtained.

In the example illustrated in FIG. 24, the image of the input image data IMi is printed on the front surface of the print medium PM by transfer. Assuming that the print medium PM is transparent, when the printed object PT10 is observed from the front surface side, the image of the input image data IMi is seen, not through the print medium PM. When the printed object PT10 is observed from the back surface side, a reversed image of the image of the input image data IMi is seen through the print medium PM.

FIG. 25 is a diagram illustrating back printing. In back printing, the printing device 400 prints the color layer CL representing the image of input image data IMi on the front surface of the transfer paper TP (print processing). Since it is back printing, the left-right reversal processing of the input image data IMi is not performed. The printed transfer paper TPp is heated in the state where the recording surface of the printed transfer paper TPp is pressed against the back surface of the print medium PM (transfer processing). As a result, a printed object PT11 is obtained.

In the example illustrated in FIG. 25, the reversed image of the image of the input image data IMi is printed on the back surface of the print medium PM by transfer. Assuming that the print medium PM is transparent, when the printed object PT11 is observed from the front surface side, the image of the input image data IMi is seen through the print medium PM.

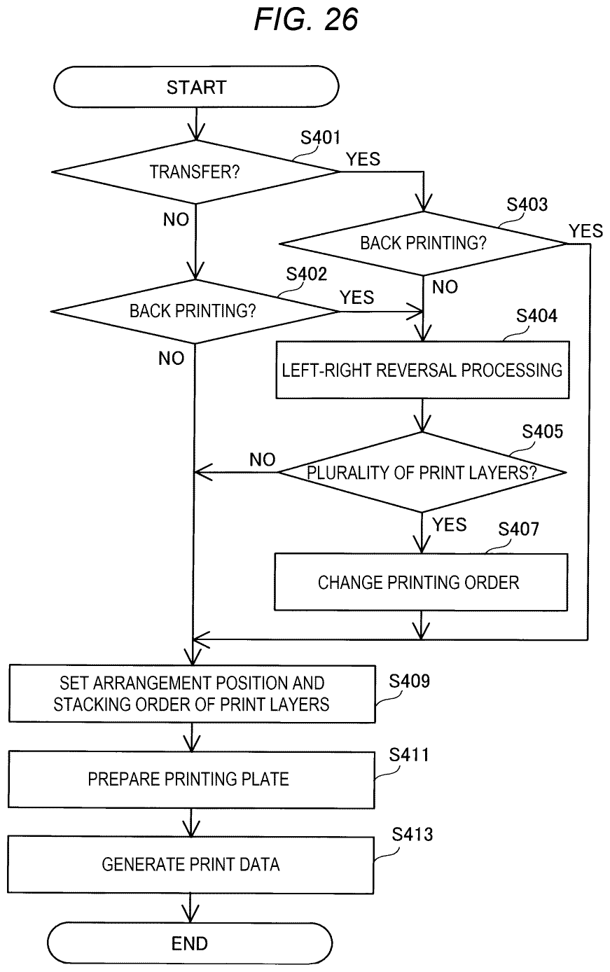

FIG. 26 is a flowchart of processing of generating print data (see step S40 in FIG. 11) according to the present embodiment. In FIG. 26, the same processing steps as in FIG. 14 of the first embodiment are denoted by the same reference signs.

In step S401, the setting unit 171 determines whether execution of transfer printing is designated. For example, the user designates whether to execute transfer printing, via a user interface, not shown.

When execution of transfer printing is designated (YES in step S401), the processing of step S403 is executed. When transfer printing is not designated (NO in step S401), the processing of step S402 is executed.

In step S402, the setting unit 171 determines whether back printing is designated. When the setting unit 171 determines that back printing is designated (YES in step S402), the processing of step S404 is executed. When the setting unit 171 determines that back printing is not designated (NO in step S402), the processing of step S409 is executed.

In step S403, the setting unit 171 determines whether back printing is designated when executing transfer printing. When back printing is designated (YES in step S403), the processing of step S409 is executed. This is because the left-right reversal processing of the image is not required since it is back printing of transfer printing. When back printing is not designated (NO in step S403), the processing of step S404 is executed. In step S404, the setting unit 171 executes the left-right reversal processing of the image.

In step S405, the setting unit 171 determines whether stacking of a plurality of print layers is designated. When stacking of a plurality of print layers is designated (YES in step S405), the processing of step S407 is executed. When stacking of a plurality of print layers is not designated (NO in step S405), the processing of step S409 is executed.

In step S407, the setting unit 171 changes the stacking order. When transfer printing is performed in front printing with a foundation layer, a color layer and a foundation layer are stacked on the recording surface of the transfer paper TP in this order from the side closer to the transfer paper TP. When transfer printing is performed by back printing with a foundation layer, a foundation layer and a color layer are stacked on the recording surface of the transfer paper TP in this order from the side closer to the transfer paper TP.

In step S409, the setting unit 171 sets an arrangement position (arrangement surface) at which the print layers are arranged on the print medium and a stacking order in which a plurality of print layers are stacked when the number of print layers is a plurality. In the case of transfer printing, the position (arrangement surface) where the print layer is arranged on the transfer paper TP, which is the print medium, is normally the front surface (recording surface). The setting unit 171 stores data representing the arrangement position and the stacking order in the memory 101.

When the print condition indicates transfer, front printing, and the presence of a foundation layer, for example, data such as “transfer: yes, arrangement position (arrangement surface): front, stacking order: medium+color layer+foundation layer” is output. When the print condition indicates transfer, back printing, and the presence of a foundation layer, for example, data such as “transfer: yes, arrangement position (arrangement surface): front, stacking order: medium+foundation layer+color layer” is output. The processing of steps S411 and S413 is the same as in the first embodiment.

As described above, in the present embodiment, when executing transfer printing, the stacking order of the print layers is determined. Also, the left-right reversal processing of the image is executed. Unlike in the related art, the user does not need to designate the stacking order of the layers or to prepare a left-right reversed image. Thus, operability in printing is improved. As a result, usability is improved.

### E. Other Embodiments

### E1. Another Embodiment 1

In the printing system 10 illustrated in FIG. 1, an example in which one printing device 400 is coupled to the image processing device 100 is described. Two or more printing devices 400 may be coupled to the image processing device 100. The printing devices may have different functions from each other. For example, two or more printing devices 400 may include a direct-to-garment (DTG) printer, a sublimation transfer (ST) printer that can perform sublimation transfer printing, and a direct-to-film (DTF) printer.

The DTG printer is a printer that can directly print on clothes. The DTF printer can perform DTF printing. DTF printing refers to a method in which an ink is attached to a recording surface of a special film by printing and in which the recording surface of the film is pressed against a print medium, and the heated, thus performing printing by heat transfer. In sublimation transfer printing, the material of the printable print medium is limited, whereas in DTF printing, a broad range of materials can be used for the printable print medium.

In the third embodiment, an example in which the setting unit 171 of the image processing device 100 determines whether transfer printing is designated by the user is described (see step S401 in FIG. 26). Alternatively, the printing device 400 may be designated via a user interface, not shown. In this case, the setting unit 171 may acquire the type of the designated printing device 400 and determine whether to execute transfer printing, according to the type of printing.

### E2. Another Embodiment 2

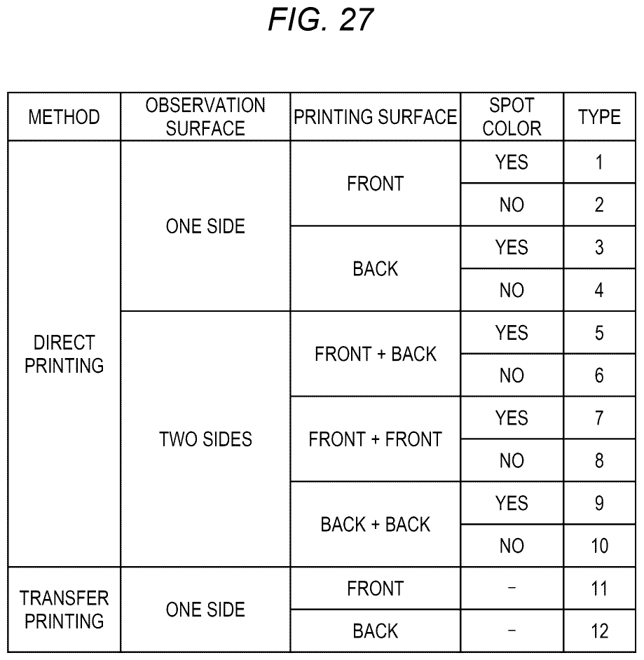

In the above embodiment, an example in which the generation of the preview image, the determination about whether the execution of the left-right reversal processing is required, the determination of the stacking order of the print layers, and the like, are performed based on the print conditions including the type of printing, is described. The types of printing in the above-described embodiment will now be described. FIG. 27 is a diagram related to forms of printing that can be supported by the image processing device 100. In order to facilitate the understanding of the technology, it is assumed that the print medium is plate-shaped in FIG. 27. In FIG. 27, first, in terms of “method”, printing is classified into different forms, that is, direct printing in which printing is directly performed on the print medium and transfer printing in which printing is performed via a medium. Also, in terms of “observation surface”, printing is classified into different forms, based on whether the surface of the printed object that is assumed to be observed is one side or both sides. In transfer printing, since there are not many cases where printing on both sides of the medium is assumed, the observation surface is only one side in transfer printing in FIG. 27. Moreover, in terms of “printing surface”, printing is classified into different forms, based on whether printing is performed on one or both of the front surface and the back surface. Also, printing is classified into different forms, based on whether to use the “spot color”. In FIG. 27, for the sake of convenience, whether to use the spot color is not defined for transfer printing. Numbers that identify the forms of printing thus classified are expressed as “type”.

For example, the printed object PT1 in FIG. 2 corresponds to Type 2. The printed object PT3 in FIG. 4 and the printed object PT5 in FIG. 5 correspond to Type 3. The printed object PT2 in FIG. 3 corresponds to Type 4.

In this way, different forms of printing can be provided, based on one of or a combination of a plurality of conditions such as front printing, back printing, double-sided printing, single-sided printing, and transfer printing, and various types of printing can be implemented. In this specification, the type of printing is specified by the form of printing.

### E3. Another Embodiment 3

In the second embodiment, an example in which the display of the front surface and the display of the back surface of the printed object are switched by the button is described (see FIG. 20). The user may switch the display of the front surface and the display of the back surface of the preview image by an intuitive operation such as a tap operation or a double tap operation.

### E4. Another Embodiment 4

In the above first embodiment, an example in which the preview images of the front and back surfaces of the printed object are displayed is described. For example, in the display area FV (see FIG. 20) on the user interface UI2, the user may freely change the position and the attitude of a virtual three-dimensional object representing a printed object.

### F. Other Aspects

The present disclosure is not limited to the above embodiments and may be implemented with various configurations without departing from the spirit and scope of the present disclosure. For example, technical features in the embodiments corresponding to technical features in the aspects described in the summary section can be replaced and combined as appropriate in order to solve a part or all of the above problems or in order to achieve a part or all of the above effects. Also, the technical features can be deleted as appropriate, unless described as essential in the present specification.

(1) According to a first aspect of the present disclosure, an image processing method is provided. The image processing method includes: (a) acquiring image data representing an image to be formed on a print medium; (b) acquiring a print condition including at least one of a type of the print medium, a type of printing, and a number of print layers; (c) displaying, on a display device, at least one preview image representing a state where the image is formed on the print medium, based on the print condition; (d) when left-right reversal processing is required based on the print condition, executing the left-right reversal processing of the image; (e) determining an arrangement position at which the print layer is arranged on the print medium and a stacking order in which a plurality of the print layers are stacked when the number of the print layers is a plurality, according to the print condition; and (f) outputting print data to a printing device, the print data designating the type of the print medium, the arrangement position, the stacking order, and the image on which the left-right reversal processing is executed or the left-right reversal processing is not executed, in order to print the image on the print medium.

According to the above aspect, when the number of print layers is plural, the stacking order in which the print layers are stacked is determined in the print condition. Therefore, unlike in the related art, the user does not need to designate the stacking order of the layers, and operability is improved. As a result, usability is improved.

(2) The image processing method according to the above aspect may further include (g) acquiring a type of a printing device that executes printing on the print medium, and in the (d), whether execution of the left-right reversal processing of the image is required may be determined in accordance with the print condition and the type of the printing device, and in the (e), the arrangement position and the stacking order when the number of the print layers is plural may be determined in accordance with the print condition and the type of the printing device, and in the (f), the print data according to the print condition and the type of the printing device may be output.

(3) In the image processing method according to the above aspect, the preview image may include an image representing a state of a front surface of the print medium and an image representing a state of a back surface of the print medium.

When the print medium is formed of a material having light transmissivity, the user can easily check the state of the front surface and the state of the back surface of the printed object.

(4) In the image processing method according to the above aspect, in the (c), a rendered image corresponding to how the print medium in a three-dimensional virtual space looks may be displayed as the preview image, and when an instruction to change a position and an attitude of the print medium in the virtual space is input via an input device operated by a user, the rendered image displayed on the display device may be updated in accordance with the instruction.

Since the print medium in the three-dimensional virtual space is displayed, the user can easily visually recognize the printed object.

(5) In the image processing method according to the above aspect, the print condition may include whether a spot color ink different from a process ink needs to be used.

(6) In the image processing method according to the above aspect, when use of a varnish ink as the spot color ink is designated in the print condition, it may be determined in the (e) that a layer formed with the process ink and a layer formed with the varnish ink are stacked on the print medium in this order, and when use of a foundation ink as the spot color ink is designated in the print condition and front printing is designated as the type of the printing, it may be determined in the (e) that a layer formed with the foundation ink and a layer formed with the process ink are stacked on the print medium in this order.

When using the spot color ink, the user does not need to designate the stacking order in which the print layers are stacked. Thus, the user can easily perform an operation for printing.

(7) In the image processing method according to the above aspect, the print medium may be formed of a material having light transmissivity, and when the use of the foundation ink as the spot color ink is designated and back printing is designated as the type of the printing in the print condition, it may be determined in the (d) that execution of the left-right reversal processing of the image is required, and it may be determined in the (e) that a layer formed with the process ink and a layer formed with the foundation ink are stacked on the print medium in this order.

When printing on a print medium formed of a material having light transmissivity, the user does not need to designate whether the execution of the left-right reversal processing is required. Also, the user can determine the stacking order of the print layers simply by designating whether to use the foundation layer ink and the selection of front printing or back printing. Thus, the user can easily perform an operation for printing.

(8) In the image processing method according to the above aspect, when transfer printing is designated as the type of the printing in the print condition, it may be determined in the (d) that execution of the left-right reversal processing of the image is required.

When performing transfer printing, the user does not need to designate whether the execution of the left-right reversal processing is required. Thus, the user can easily perform an operation for printing.

(9) In the image processing method according to the above aspect, when double-sided printing is designated as the type of the printing in the print condition, the print data related to the front surface and the print data related to the back surface may be generated in the (f).

(10) In the image processing method according to the above aspect, the type of the printing may be determined, based on one of or a combination of a plurality of conditions, of front printing, back printing, double-sided printing, single-sided printing, and whether to perform transfer printing.

(11) According to a second aspect of the present disclosure, an image processing device is provided. The image processing device includes: an image data acquisition unit that acquires image data representing an image to be formed on a print medium; a print condition acquisition unit that acquires a print condition including at least one of a type of the print medium, a type of printing, and a number of print layers; a preview image generation unit that displays, on a display device, a preview image representing a state where the image is formed on the print medium, based on the print condition; and a print data generation unit that, when left-right reversal processing is required based on the print condition, executes the left-right reversal processing of the image, determines an arrangement position at which the print layer is arranged on the print medium and a stacking order in which a plurality of the print layers are stacked when the number of the print layers is a plurality, according to the print condition, and outputs print data to a printing device, the print data designating the type of the print medium, the arrangement position, the stacking order, and the image on which the left-right reversal processing is executed or the left-right reversal processing is not executed, in order to print the image on the print medium.

According to the above aspect, when the number of print layers is plural, the stacking order in which the print layers are stacked is determined in the print condition. Therefore, unlike in the related art, the user does not need to designate the stacking order of the layers, and operability is improved. As a result, usability is improved.

(12) According to a third aspect of the present disclosure, a printing system is provided. The printing system includes an image processing device, a printing device, and a display device. The image processing device includes: an image data acquisition unit that acquires image data representing an image to be formed on a print medium; a print condition acquisition unit that acquires a print condition including at least one of a type of the print medium, a type of printing, and a number of print layers; a preview image generation unit that displays, on the display device, a preview image representing a state where the image is formed on the print medium, based on the print condition; and a print data generation unit that, when left-right reversal processing is required based on the print condition, executes the left-right reversal processing of the image, determines an arrangement position at which the print layer is arranged on the print medium and a stacking order in which a plurality of the print layers are stacked when the number of the print layers is a plurality, according to the print condition, and outputs print data to the printing device, the print data designating the type of the print medium, the arrangement position, the stacking order, and the image on which the left-right reversal processing is executed or the left-right reversal processing is not executed, in order to print the image on the print medium. The printing device receives the print data, and executes printing on the print medium, based on the print condition included in the print data.

According to the above aspect, when the number of print layers is plural, the stacking order in which the print layers are stacked is determined in the print condition. Therefore, unlike in the related art, the user does not need to designate the stacking order of the layers, and operability is improved. As a result, usability is improved.

(13) According to a fourth aspect of the present disclosure, a non-transitory computer-readable storage medium storing an image processing program is provided. The image processing program causes a computer to implement: a function of acquiring image data representing an image to be formed on a print medium; a function of acquiring a print condition including at least one of a type of the print medium, a type of printing, and a number of print layers; a function of displaying, on a display device, a preview image representing a state where the image is formed on the print medium, based on the print condition; a function of, when left-right reversal processing is required based on the print condition, executing the left-right reversal processing of the image; a function of determining an arrangement position at which the print layer is arranged on the print medium and a stacking order in which a plurality of the print layers are stacked when the number of the print layers is a plurality, according to the print condition; and a function of outputting print data to a printing device, the print data designating the type of the print medium, the arrangement position, the stacking order, and the image on which the left-right reversal processing is executed or the left-right reversal processing is not executed, in order to print the image on the print medium.

According to the above aspect, when the number of print layers is plural, the stacking order in which the print layers are stacked is determined in the print condition. Therefore, unlike in the related art, the user does not need to designate the stacking order of the layers, and operability is improved. As a result, usability is improved.

What is claimed is:

1. An image processing method comprising:
(a) acquiring image data representing an image to be formed on a print medium;
(b) acquiring a print condition including at least one of a type of the print medium, a type of printing, and a number of print layers;
(c) displaying, on a display device, at least one preview image representing a state where the image is formed on the print medium, based on the print condition;
(d) when left-right reversal processing is required based on the print condition, executing the left-right reversal processing of the image;
(e) determining an arrangement position at which the print layer is arranged on the print medium and a stacking order in which a plurality of the print layers are stacked when the number of the print layers is a plurality, according to the print condition; and
(f) outputting print data to a printing device, the print data designating the type of the print medium, the arrangement position, the stacking order, and the image on which the left-right reversal processing is executed or the left-right reversal processing is not executed, in order to print the image on the print medium.

2. The image processing method according to claim 1, further comprising:
(g) acquiring a type of a printing device that executes printing on the print medium, wherein
in the (d), whether execution of the left-right reversal processing of the image is required is determined in accordance with the print condition and the type of the printing device,
in the (e), the arrangement position and the stacking order when the number of the print layers is plural are determined in accordance with the print condition and the type of the printing device, and
in the (f), the print data according to the print condition and the type of the printing device is output.

3. The image processing method according to claim 2, wherein
the preview image includes an image representing a state of a front surface of the print medium and an image representing a state of a back surface of the print medium.

4. The image processing method according to claim 3, wherein
in the (c),
a rendered image corresponding to how the print medium in a three-dimensional virtual space looks is displayed as the preview image, and
when an instruction to change a position and an attitude of the print medium in the virtual space is input via an input device operated by a user, the rendered image displayed on the display device is updated in accordance with the instruction.

5. The image processing method according to claim 4, wherein
the print condition includes whether a spot color ink different from a process ink needs to be used.

6. The image processing method according to claim 5, wherein
when use of a varnish ink as the spot color ink is designated in the print condition,
it is determined in the (e) that a layer formed with the process ink and a layer formed with the varnish ink are stacked on the print medium in this order, and
when use of a foundation ink as the spot color ink is designated in the print condition and front printing is designated as the type of the printing,
it is determined in the (e) that a layer formed with the foundation ink and a layer formed with the process ink are stacked on the print medium in this order.

7. The image processing method according to claim 6, wherein
the print medium is formed of a material having light transmissivity, and
when the use of the foundation ink as the spot color ink is designated and back printing is designated as the type of the printing in the print condition,
it is determined in the (d) that execution of the left-right reversal processing of the image is required, and
it is determined in the (e) that a layer formed with the process ink and a layer formed with the foundation ink are stacked on the print medium in this order.

8. The image processing method according to claim 7, wherein
when transfer printing is designated as the type of the printing in the print condition,
it is determined in the (d) that execution of the left-right reversal processing of the image is required.

9. The image processing method according to claim 8, wherein
when double-sided printing is designated as the type of the printing in the print condition,
the print data related to the front surface and the print data related to the back surface are generated in the (f).

10. The image processing method according to claim 8, wherein
the type of the printing is determined, based on one of or a combination of a plurality of conditions, of front printing, back printing, an observation surface assumed to be used to observe a printed object, and whether to perform transfer printing.

11. The image processing device comprising:
an image data acquisition unit that acquires image data representing an image to be formed on a print medium;
a print condition acquisition unit that acquires a print condition including at least one of a type of the print medium, a type of printing, and a number of print layers;
a preview image generation unit that displays, on a display device, a preview image representing a state where the image is formed on the print medium, based on the print condition; and
a print data generation unit that,
when left-right reversal processing is required based on the print condition, executes the left-right reversal processing of the image,
determines an arrangement position at which the print layer is arranged on the print medium and a stacking order in which a plurality of the print layers are stacked when the number of the print layers is a plurality, according to the print condition, and
outputs print data to a printing device, the print data designating the type of the print medium, the arrangement position, the stacking order, and the image on which the left-right reversal processing is executed or the left-right reversal processing is not executed, in order to print the image on the print medium.

12. A printing system comprising:
an image processing device, a printing device, and a display device,
the image processing device comprising:
an image data acquisition unit that acquires image data representing an image to be formed on a print medium;
a print condition acquisition unit that acquires a print condition including at least one of a type of the print medium, a type of printing, and a number of print layers;
a preview image generation unit that displays, on the display device, a preview image representing a state where the image is formed on the print medium, based on the print condition; and
a print data generation unit that,
when left-right reversal processing is required based on the print condition, executes the left-right reversal processing of the image,
determines an arrangement position at which the print layer is arranged on the print medium and a stacking order in which a plurality of the print layers are stacked when the number of the print layers is a plurality, according to the print condition, and
outputs print data to the printing device, the print data designating the type of the print medium, the arrangement position, the stacking order, and the image on which the left-right reversal processing is executed or the left-right reversal processing is not executed, in order to print the image on the print medium,
the printing device:
receiving the print data; and
executing printing on the print medium, based on the print condition included in the print data.

13. A non-transitory computer-readable storage medium storing an image processing program, the image processing program causing a computer to implement:
a function of acquiring image data representing an image to be formed on a print medium;
a function of acquiring a print condition including at least one of a type of the print medium, a type of printing, and a number of print layers;
a function of displaying, on a display device, a preview image representing a state where the image is formed on the print medium, based on the print condition;
a function of, when left-right reversal processing is required based on the print condition, executing the left-right reversal processing of the image;
a function of determining an arrangement position at which the print layer is arranged on the print medium and a stacking order in which a plurality of the print layers are stacked when the number of the print layers is a plurality, according to the print condition; and
a function of outputting print data to a printing device, the print data designating the type of the print medium, the arrangement position, the stacking order, and the image on which the left-right reversal processing is executed or the left-right reversal processing is not executed, in order to print the image on the print medium.
